(19) United States
(12) Patent Application Publication
(10) Pub. No.: US 2025/0371089 A1
(43) Pub. Date: Dec. 4, 2025

(54) MEDIA DATA RECOMMENDATION

(71) Applicant: TENCENT TECHNOLOGY (SHENZHEN) COMPANY LIMITED, Shenzhen (CN)

(72) Inventors: Jiahua RAO, Shenzhen (CN); Zifei SHAN, Shenzhen (CN); Longpo LIU, Shenzhen (CN); Yao ZHOU, Shenzhen (CN)

(73) Assignee: TENCENT TECHNOLOGY (SHENZHEN) COMPANY LIMITED, Shenzhen, GD (CN)

(21) Appl. No.: 19/305,113

(22) Filed: Aug. 20, 2025

Related U.S. Application Data
(63) Continuation of application No. PCT/CN2023/134940, filed on Nov. 29, 2023.

(30) Foreign Application Priority Data
Jul. 18, 2023 (CN) 202310880240.4

(51) Int. Cl. G06F 16/9535; G06F 16/334

(52) U.S. Cl. CPC G06F 16/9535; G06F 16/3347

(57) ABSTRACT

In a method of media data recommendation, a media representation vector is extracted from media data and a text representation vector is extracted from a description text of the media data. A knowledge retrieval is performed in a knowledge graph according to the media representation vector, to obtain an entity sub-graph of the media data. An entity representation vector of the entity sub-graph is determined. A feature fusion processing is performed on the media representation vector, the text representation vector, and the entity representation vector, to obtain a knowledge augmented vector. Target media data is obtained based on the knowledge augmented vector that is a fused vector of the media representation vector, the text representation vector, and the entity representation vector. The target media data is recommended to a target object. Apparatus and non-transitory computer-readable storage medium counterpart embodiments are also contemplated.

### RELATED APPLICATIONS

The present application is a continuation of International Application No. PCT/CN2023/134940, filed on Nov. 29, 2023, which claims priority to Chinese Patent Application No. 202310880240.4, filed on Jul. 18, 2023. The entire disclosures of the prior applications are hereby incorporated by reference.

### FIELD OF THE TECHNOLOGY

This disclosure relates to the field of computer technologies, including a media data recommendation method and apparatus, a computer device, a storage medium, and a computer program product.

### BACKGROUND OF THE DISCLOSURE

With the development of Internet technologies, media browsing becomes more and more popular among people. In a related technology, a recommendation system may determine, according to media content watched by an object, other media in which the object may be interested, and the determined other media in which the object may be interested is mostly media highly similar to the watched media content, easily leading to monotonous recommendation.

### SUMMARY

According to various embodiments provided in this application, a media data recommendation method and apparatus, a computer device, a computer-readable storage medium, and a computer program product are provided.

Some aspects of the disclosure provide a method of media data recommendation. In some examples, a media representation vector is extracted from media data and a text representation vector is extracted from a description text of the media data. A knowledge retrieval is performed in a knowledge graph according to the media representation vector, to obtain an entity sub-graph of the media data. An entity representation vector of the entity sub-graph is determined. A feature fusion processing is performed on the media representation vector, the text representation vector, and the entity representation vector, to obtain a knowledge augmented vector. Target media data is obtained based on the knowledge augmented vector that is a fused vector of the media representation vector, the text representation vector, and the entity representation vector. The target media data is recommended to a target object.

Some aspects of the disclosure provide an apparatus that includes processing circuitry configured to perform the method of media data recommendation.

Some aspects of the disclosure also provide a non-transitory computer-readable storage medium storing instructions which when executed by at least one processor cause the at least one processor to perform the method of media data recommendation.

Some aspects of the disclosure provide a method of recommendation model processing. In some examples, by using one or more feature extraction models, a first media training vector is extracted from first sample media data and a first text training vector is extracted from a first sample text of the first sample media data. By using a knowledge retrieval model, a knowledge retrieval processing is performed on the first media training vector and a knowledge graph to obtain a training sub-graph of the first sample media data. An entity training vector of the training sub-graph is determined. By using a knowledge augmented model, a feature fusion processing is performed on the first media training vector, the first text training vector, and the entity training vector to obtain a knowledge augmented training vector. A visual loss value and a language loss value are determined according to the knowledge augmented training vector and a sample label of the first sample media data. A knowledge retrieval loss value is determined according to the knowledge augmented training vector and the training sub-graph. Parameters of the one or more feature extraction models, the knowledge retrieval model, and the knowledge augmented model are adjusted based on the visual loss value, the language loss value, and the knowledge retrieval loss value, to obtain an augmented vector extraction model. The augmented vector extraction model includes the one or more feature extraction models, the knowledge retrieval model and the knowledge augmented model. A recommendation model is determined based on the augmented vector extraction model and a classification model, the recommendation model includes the augmented vector extraction model and the classification model, the recommendation model provides target media data to a target object based on media data, a description text of the media data and the knowledge graph.

Some aspects of the disclosure provide an apparatus that includes processing circuitry configured to perform the method of recommendation model processing X.

Some aspects of the disclosure also provide a non-transitory computer-readable storage medium storing instructions which when executed by at least one processor cause the at least one processor to perform the method of recommendation model processing.

According to a first aspect, this application provides a media data recommendation method, performed by a server, including: extracting a media representation vector and a text representation vector from media data and a description text of the media data; performing knowledge retrieval in a knowledge graph according to the media representation vector, to obtain an entity sub-graph of the media data, and determining an entity representation vector of the entity sub-graph; performing feature fusion processing on the media representation vector, the text representation vector, and the entity representation vector, to obtain a knowledge augmented vector; and obtaining target media data based on the knowledge augmented vector, and recommending the target media data to a target object.

According to a second aspect, this application further provides a media data recommendation apparatus, including: a vector extraction module, configured to extract a media representation vector and a text representation vector from media data and a description text of the media data; a first knowledge retrieval module, configured to perform knowledge retrieval in a knowledge graph according to the media representation vector, to obtain an entity sub-graph of the media data, and determine an entity representation vector of the entity sub-graph; a first fusion module, configured to perform feature fusion processing on the media representation vector, the text representation vector, and the entity representation vector, to obtain a knowledge augmented vector; and a recommendation module, configured to obtain target media data based on the knowledge augmented vector, and recommend the target media data to a target object.

According to a third aspect, this application further provides a computer device, including a memory and a processor, the memory having a computer program stored therein, and when the processor executes the computer program, the media data recommendation method according to the first aspect being implemented.

According to a fourth aspect, this application further provides a computer-readable storage medium, having a computer program stored therein, when the computer program is executed by a processor, the media data recommendation method according to the first aspect being implemented.

According to a fifth aspect, this application further provides a computer program product, including a computer program, when the computer program is executed by a processor, the media data recommendation method according to the first aspect being implemented.

According to a sixth aspect, this application provides a recommendation model processing method, performed by a server, including: extracting a first media training vector and a first text training vector from first sample media data and a corresponding first sample text based on a feature extraction model; performing knowledge retrieval processing on the first media training vector and a knowledge graph based on a knowledge retrieval model, to obtain a training sub-graph of the first sample media data, and determining an entity training vector of the training sub-graph; performing feature fusion processing on the first media training vector, the first text training vector, and the entity training vector based on a knowledge augmented model, to obtain a knowledge augmented training vector; determining a visual loss value and a language loss value according to the knowledge augmented training vector and a sample label; determining a knowledge retrieval loss value according to the knowledge augmented training vector and the training sub-graph; adjusting parameters of the feature extraction model, the knowledge retrieval model, and the knowledge augmented model based on the visual loss value, the language loss value, and the knowledge retrieval loss value, to obtain an augmented vector extraction model; and determining a recommendation model based on the augmented vector extraction model and a classification model, the recommendation model being configured for extracting a knowledge augmented vector according to media data, a description text, and the knowledge graph, and determining an interest type based on the knowledge augmented vector, to obtain target media data based on the interest type and recommend the target media data to a target object.

According to a seventh aspect, this application further provides a recommendation model processing apparatus, including: a training vector extraction module, configured to extract a first media training vector and a first text training vector from first sample media data and a corresponding first sample text based on a feature extraction model; a second knowledge retrieval module, configured to: perform knowledge retrieval processing on the first media training vector and a knowledge graph based on a knowledge retrieval model, to obtain a training sub-graph of the first sample media data, and determine an entity training vector of the training sub-graph; a second fusion module, configured to perform feature fusion processing on the first media training vector, the first text training vector, and the entity training vector based on a knowledge augmented model, to obtain a knowledge augmented training vector; a first loss value determining module, configured to determine a visual loss value and a language loss value according to the knowledge augmented training vector and a sample label; a second loss value determining module, configured to determine a knowledge retrieval loss value according to the knowledge augmented training vector and the training sub-graph; a parameter adjustment module, configured to adjust parameters of the feature extraction model, the knowledge retrieval model, and the knowledge augmented model based on the visual loss value, the language loss value, and the knowledge retrieval loss value, to obtain an augmented vector extraction model; and a recommendation model determining module, configured to determine a recommendation model based on the augmented vector extraction model and a classification model, the recommendation model being configured for extracting a knowledge augmented vector according to media data, a description text, and the knowledge graph, and determining an interest type based on the knowledge augmented vector, to obtain target media data based on the interest type and recommend the target media data to a target object.

According to an eighth aspect, this application further provides a computer device, including a memory and a processor, the memory having a computer program stored therein, and when the processor (an example of processing circuitry) executes the computer program, the recommendation model processing method according to the sixth aspect being implemented.

According to a ninth aspect, this application further provides a computer-readable storage medium (e.g., non-transitory computer-readable storage medium), having a computer program stored therein, when the computer program is executed by a processor, the recommendation model processing method according to the sixth aspect being implemented.

According to a tenth aspect, this application further provides a computer program product, including a computer program, when the computer program is executed by a processor, the recommendation model processing method according to the sixth aspect being implemented.

Details of one or more embodiments of this application are provided in the accompanying drawings and descriptions below.

### BRIEF DESCRIPTION OF THE DRAWINGS

FIG. 1 is a diagram of an application environment of a media data recommendation method according to an embodiment;

FIG. 2 is a schematic flowchart of a media data recommendation method according to an embodiment;

FIG. 3 is a schematic diagram of extracting a media representation vector according to an embodiment;

FIG. 4 is a schematic diagram of extracting a text representation vector according to an embodiment;

FIG. 5 is a schematic diagram of determining target media data based on media data, a description text, and a knowledge graph according to an embodiment;

FIG. 6 is a schematic diagram of determining an entity representation vector according to an embodiment;

FIG. 7 is a schematic diagram of determining a knowledge augmented vector according to an embodiment;

FIG. 8 is a schematic structural diagram of a recommendation model according to an embodiment;

FIG. 9 is a schematic diagram of a media data recommendation method according to another embodiment;

FIG. 10 is a schematic diagram of a recommendation model processing method according to an embodiment;

FIG. 11 is a schematic diagram of determining a first media training vector according to an embodiment;

FIG. 12 is a schematic diagram of determining a first text training vector according to an embodiment;

FIG. 13 is a schematic diagram of determining a knowledge augmented training vector in a training process of an augmented vector extraction model according to an embodiment;

FIG. 14 is a schematic diagram of a recommendation model processing method according to another embodiment;

FIG. 15 is a structural block diagram of a media data recommendation apparatus according to an embodiment;

FIG. 16 is a structural block diagram of a recommendation model processing apparatus according to an embodiment; and

FIG. 17 is a diagram of an internal structure of a computer device according to an embodiment.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

In the specification and accompanying drawings, operations and elements that are basically the same or similar are represented by the same or similar reference signs, and repeated descriptions of these operations and elements are omitted. In addition, in descriptions of this application, terms such as “first” and “second” are used for distinguishing purpose, and cannot be understood as indicating or implying relative importance or a sequence.

A media data recommendation method provided in an embodiment of this disclosure may be applied to an application environment shown in FIG. 1. In the figure, a terminal 102 communicates with a server 104 through a network. A data storage system may store data that the server 104 needs to process. The data storage system may be integrated in the server 104, or may be deployed on cloud or another network server. The media data recommendation method may be performed by the terminal 102, or may be performed by the server 104, or may be collaboratively performed by the terminal 102 and the server 104.

For example, the media data recommendation method is performed by the server 104. The server 104 may extract a media representation vector and a text representation vector from media data and a description text of the media data. The server 104 may perform knowledge retrieval in a knowledge graph according to the media representation vector, to obtain an entity sub-graph of the media data, and determine an entity representation vector of the entity sub-graph. The server 104 may perform feature fusion processing on the media representation vector, the text representation vector, and the entity representation vector, to obtain a knowledge augmented vector. The server 104 may further obtain target media data based on the knowledge augmented vector, and recommend the target media data to a target object.

The terminal 102 may be a smartphone, a tablet computer, a notebook computer, a desktop computer, a smart speaker, a smart watch, an internet of things device, and a portable wearable device. The internet of things device may be a smart speaker, a smart television, a smart air conditioner, a smart vehicle-mounted device, or the like. The portable wearable device may be a smart watch, a smart band, a head-mounted device, or the like.

The server 104 may be an independent physical server or may be a serving node in a blockchain system. A peer to peer (P2P) network is formed between serving nodes in the blockchain system. A P2P protocol is an application-layer protocol running over a transmission control protocol (TCP).

In addition, the server 104 may be a server cluster including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

The terminal 102 and the server 104 may be connected through a communication connection mode such as a Bluetooth, a universal serial bus (USB), or a network. This is not limited in this disclosure.

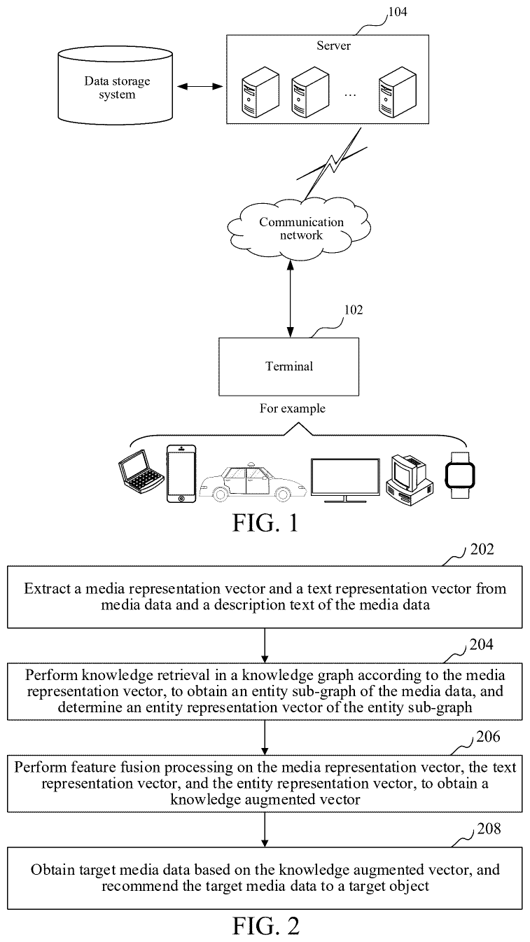

In some embodiments, as shown in FIG. 2, a media data recommendation method is provided. The method may be performed by the terminal or the server in FIG. 1, and may also be performed jointly by the terminal and the server in FIG. 1. For example, the method is performed by the server in FIG. 1. The method includes the following operations:

Operation 202: Extract a media representation vector and a text representation vector from media data and a description text of the media data.

The media data is media data that is being browsed by a target object, or may be media data that has been browsed by a target object. The media data may be a video, an image, or a live streaming channel. The target object is a user. During media data recommendation, media data that is being browsed by a user or media data that has been browsed by the user may be media data in which the user is interested. Recommendation according to the media data in which the user may be interested can improve a matching degree between recommended media data and preference of the user.

The description text is used for describing content of the media data. Exemplarily, the media data is a video, for example, content of the video is that a kitten eats fish, and a description text of the video may be: “Newly bought dried fish is delivered and the kitten eats pleasantly”. Exemplarily, the media data is an image, for example, content of the image is that a baseball player throws a ball in a game, and a description text of the image may be: “a baseball player throws a ball”.

The media representation vector is obtained by extracting features of the media data, and is used to reflect content of the media data. The text representation vector is obtained by extracting features of the description text, and is used to reflect content of the description text.

In some embodiments, a server may obtain media data that is being browsed by a target object and a description text of the media data. Alternatively, the server may obtain media data that has been browsed by a target object and a description text of the media data. The server may extract the media representation vector from the media data and extract the text representation vector from the description text by using a feature extraction model.

For example, the server inputs the media data and the description text to the feature extraction model, and extracts the media representation vector of the media data and extracts the text representation vector of the description text by using the feature extraction model.

In some embodiments, operation 202 includes: extracting features of the media data by using an image feature extraction model, to obtain the media representation vector; and extracting the text representation vector from the description text of the media data by using a text feature extraction model.

The image feature extraction model includes a first self-attention layer and a visual feedforward layer. The text feature extraction model includes a second self-attention layer and a text feedforward layer.

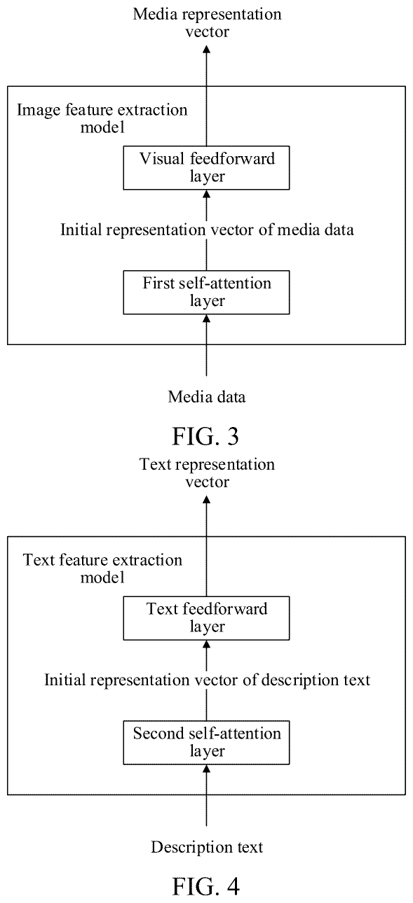

As shown in FIG. 3, media data is inputted to an image feature extraction model, an initial representation vector of the media data is outputted by using a first self-attention layer, and the initial representation vector of the media data is processed by using a visual feedforward layer, to obtain a media representation vector.

As shown in FIG. 4, a description text is inputted to a text feature extraction model, an initial representation vector of the description text is outputted by using a second self-attention layer, and the initial representation vector of the description text is processed by using a text feedforward layer, to obtain a text representation vector.

In the foregoing embodiment, the media representation vector of the media data is extracted by using the image feature extraction model, and the text representation vector of the description text is extracted by using the text feature extraction model, so that the media representation vector can reflect content of the media data, and the text representation vector can reflect content of the description text, thereby improving quality of the media representation vector and the text representation vector.

In some embodiments, the extracting features of the media data by using an image feature extraction model, to obtain the media representation vector includes: extracting, when the media data is a video, features of a plurality of image frames in the video by using the image feature extraction model, to obtain the media representation vector; and extracting, when the media data is an image, features of a plurality of image blocks of the image by using the image feature extraction model, to obtain the media representation vector.

The plurality of image frames may be some image frames in the video, a quantity of the plurality of image frames may be a first preset quantity, and a size of the image frame may be a preset size. The first preset quantity and the preset size can be both set according to actual needs. The first preset quantity and the preset size are not limited in this embodiment of this disclosure.

The plurality of image blocks may be obtained by dividing the image, a quantity of the plurality of image blocks may be the first preset quantity, and a size of the image block may be the preset size. That is, the size of the image block is the same as the size of the image frame, and the quantity of the plurality of image blocks is the same as the quantity of the plurality of image frames.

When the media data is a video, the server may sample the video to obtain the first preset quantity of image frames, and fill or cut the first preset quantity of image frames, so that sizes of the first preset quantity of image frames are all the preset size. The server inputs the first preset quantity of image frames to the image feature extraction model, and outputs the media representation vector by using the image feature extraction model. The media representation vector includes an image representation sub-vector of each image frame, that is, the media representation vector includes the first preset quantity of image representation sub-vectors.

When the media data is an image, the server may cut the image to obtain the first preset quantity of image blocks, and fill or cut the first preset quantity of image blocks, so that sizes of the first preset quantity of image blocks are all the preset size. The server inputs the first preset quantity of image blocks to the image feature extraction model, and outputs the media representation vector by using the image feature extraction model. The media representation vector includes an image representation sub-vector of each image block, that is, the media representation vector includes the first preset quantity of image representation sub-vectors.

In some embodiments, the media data may alternatively be a live streaming channel. When the media data is a live streaming channel, features of a plurality of live streaming image frames in the live streaming channel are extracted by using the image feature extraction model, to obtain the media representation vector.

The plurality of live streaming image frames may be some image frames of images already played in the live streaming channel, a quantity of the plurality of live streaming image frames may be a first preset quantity, and a size of the live streaming image frame may be a preset size.

In the foregoing embodiment, the media data may be a video, or may be an image, so that the media data recommendation method may be applicable to a scenario of recommending target media data during video browsing or image browsing, thereby improving applicability of the media data recommendation method.

Operation 204: Perform knowledge retrieval in a knowledge graph according to the media representation vector, to obtain an entity sub-graph of the media data, and determine an entity representation vector of the entity sub-graph.

The knowledge graph includes a plurality of entities and relationships between the plurality of entities. The knowledge graph is a graph of connection lines between nodes, nodes are used to represent entities, and connection lines between the nodes are used to represent relationships between the nodes. A plurality of entity relationships may be obtained by using the knowledge graph. Exemplarily, an entity relationship may be obtained from the knowledge graph: {E1, r1, E2}, where E1 is a first entity, E2 is a second entity, and r1 is an entity relationship between the first entity and the second entity. For example, the first entity is ball, the second entity is table tennis, and the relationship is a belonging relationship. In the graph of connection lines between nodes, the first entity is represented by a node E1, the second entity is represented by a node E2, and the entity relationship r1 between the first entity and the second entity is represented by a connection line r1 between the node E1 and the node E2.

In an actual application, the knowledge graph may be constructed by a backend of an application for browsing the media data. Exemplarily, the target object browses the media data in an instant messaging application, and the knowledge graph is constructed by a backend of the instant messaging application.

The entity sub-graph is a part of the knowledge graph. The entity sub-graph relates to a plurality of entities. The plurality of entities are some of all entities included in the knowledge graph. The entity sub-graph may be used for reflecting relationships between the plurality of entities in the knowledge graph.

Exemplarily, all entities included in the knowledge graph are respectively: E1, E2, E3, . . . , and En, the plurality of entities included in the entity sub-graph are respectively: E1, E2, . . . ,and Eu, and the entity sub-graph is used for reflecting relationships between E1, E2, . . . , and Eu in the knowledge graph.

The entity representation vector is used to reflect a plurality of entities in the entity sub-graph and relationships between the plurality of entities.

In some embodiments, the server determines representation vectors of a plurality of entities in the knowledge graph; selects, according to the representation vectors of the entities and the media representation vector, entities related to the media data from the plurality of entities in the knowledge graph; determines the entity sub-graph of the media data according to the plurality of entities related to the media data and relationships between the plurality of entities in the knowledge graph; and extracts features of the entity sub-graph to obtain the entity representation vector.

In some embodiments, the selecting, by the server according to the plurality of entity representation vectors and the media representation vector, a plurality of entities related to the media data from the plurality of entities in the knowledge graph may be: determining, by the server, similarity degrees between the media representation vector and the plurality of entity representation vectors; sorting the plurality of entity representation vectors according to a descending order of the similarity degrees, to obtain an entity representation vector sequence; selecting, from the entity representation vector sequence, a second preset quantity of target entity representation vectors that are sorted in front, and using, as the plurality of entities related to the media data, entities represented by the plurality of target entity representation vectors.

In some embodiments, after determining the plurality of entities related to the media data, the server may obtain a neighboring entity of each entity from the knowledge graph, and determine the entity sub-graph of the media data according to the plurality of entities, the neighboring entity of each entity, and relationships between a plurality of entities and a plurality of neighboring entities in the knowledge graph.

Operation 206: Perform feature fusion processing on the media representation vector, the text representation vector, and the entity representation vector, to obtain a knowledge augmented vector.

The knowledge augmented vector is obtained by fusing knowledge information of entities with the media representation vector and the text representation vector.

In some embodiments, the server may separately obtain preset weights of the media representation vector, the text representation vector, and the entity representation vector, and perform weighted summation according to the media representation vector, the text representation vector, the entity representation vector, the preset weight of the media representation vector, the preset weight of the text representation vector, and the preset weight of the entity representation vector, to obtain the knowledge augmented vector.

A sum of the preset weight of the media representation vector, the preset weight of the text representation vector, and the preset weight of the entity representation vector is 1. When the preset weight of the media representation vector, the preset weight of the text representation vector, and the preset weight of the entity representation vector are all the same, it is equivalent to averaging the media representation vector, the text representation vector, and the entity representation vector.

In some embodiments, the server may concatenate the media representation vector and the text representation vector, to obtain a first concatenated vector, and the server extracts features of the first concatenated vector by using a self-attention network, to obtain a first fusion vector. The server separately obtains weights of the first fusion vector and the text representation vector, and performs weighting processing on the first fusion vector and the text representation vector according to the weight of the first fusion vector and the weight of the text representation vector, to obtain the knowledge augmented vector.

In some embodiments, the server may concatenate the media representation vector and the entity representation vector, to obtain a second concatenated vector, and concatenate the text representation vector and the entity representation vector, to obtain a third concatenated vector. The server extracts features of the second concatenated vector by using a self-attention network, to obtain a second fusion vector, and extracts features of the third concatenated vector by using a self-attention network, to obtain a third fusion vector. The server separately obtains a weight of the second fusion vector and a weight of the third fusion vector, and performs weighting processing on the second fusion vector and the third fusion vector according to the weight of the second fusion vector and the weight of the third fusion vector, to obtain the knowledge augmented vector.

In some embodiments, the server concatenates the media representation vector, the text representation vector, and the entity representation vector, to obtain a concatenated vector, and extracts features of the concatenated vector by using a self-attention network, to obtain the knowledge augmented vector.

In some embodiments, the server performs weighted summation on the media representation vector, the text representation vector, and the entity representation vector according to the preset weight of the media representation vector, the preset weight of the text representation vector, and the preset weight of the entity representation vector, to obtain a fusion vector, and extracts features of the fusion vector by using a self-attention network, to obtain the knowledge augmented vector.

Operation 208: Obtain target media data based on the knowledge augmented vector, and recommend the target media data to a target object.

The target media data is media data recommended to the target object.

In some embodiments, the knowledge augmented vector is obtained by fusing knowledge information of entities with the media representation vector and the text representation vector, and the knowledge augmented vector can reflect content of the media data and the description text, and entity information related to the media data. Therefore, by obtaining the target media data based on the knowledge augmented vector, the target media data whose content is related to the media data and the description text and whose entity is related to the media data can be obtained.

In some embodiments, operation 208 includes: performing classification processing on the knowledge augmented vector, to obtain an interest type of the target object; and obtaining the target media data according to the interest type, and recommending the target media data to a target object.

The interest type is a type in which the target object may be interested, and there may be one or more interest types. There may be one or more pieces of target media data.

In some embodiments, the server inputs the knowledge augmented vector to a classification model, obtains, by using the classification model, a prediction probability that the knowledge augmented vector belongs to each preset type, selects a target probability from a plurality of prediction probabilities, where the selected target probability is greater than a prediction probability that is not selected, and uses a prediction type corresponding to the selected target probability as the interest type of the target object. When one target probability is selected, one interest type is determined, and when a plurality of target probabilities are selected, a plurality of interest types are determined.

When there is one interest type, the server may select the target media data from a plurality of pieces of candidate media data belonging to the interest type. The server obtains popularity values of the plurality of pieces of candidate media data, and may select, from the plurality of pieces of candidate media data, candidate media data with the largest popularity value as the target media data, or may select, from the plurality of pieces of candidate media data, a plurality of pieces of candidate media data with larger popularity values as the target media data. A popularity value of the target media data is greater than a popularity value of candidate media data that is not selected. In an actual application, the popularity value of the candidate media data may be determined according to a viewing quantity, a comment quantity, and a like quantity of the candidate media data.

When there are a plurality of interest types, the server may select, from a plurality of pieces of candidate media data respectively belonging to the plurality of interest types, target media data belonging to each interest type, to obtain a plurality of pieces of target media data.

When there is one piece of target media data, the server may send the target media data to a terminal used by the target object to browse the media data. When the target object triggers an operation of switching to next media data in a process of browsing media data, the terminal may play the target media data.

When there is a plurality of pieces of target media data, the server may sort the plurality of pieces of target media data in descending order of popularity values, to obtain a target media data list, and send the target media data list to a terminal used by the target object to browse media data. The terminal may display the target media data list in a recommendation area of a browsing page of media data, and in response to a trigger operation on any target media data in the target media data list, play the target media data on which the trigger operation is performed. When the target object triggers an operation of switching to next media data in a process of browsing media data, the terminal may play target media data sorted in the first place in the target media data list.

In the foregoing embodiment, the interest type of the target object is determined for the knowledge augmented vector, so that the target media data whose content is related to the media data and the description text and whose entity is related to the media data can be obtained, thereby improving correlation between the target media data and the media data. Therefore, the target media data may be media data in which the target object is interested, thereby improving media recommendation. In this way, the target object can browse the media data in which the target object is interested without performing manual search, thereby reducing resource consumption caused by manual search and improving resource utilization.

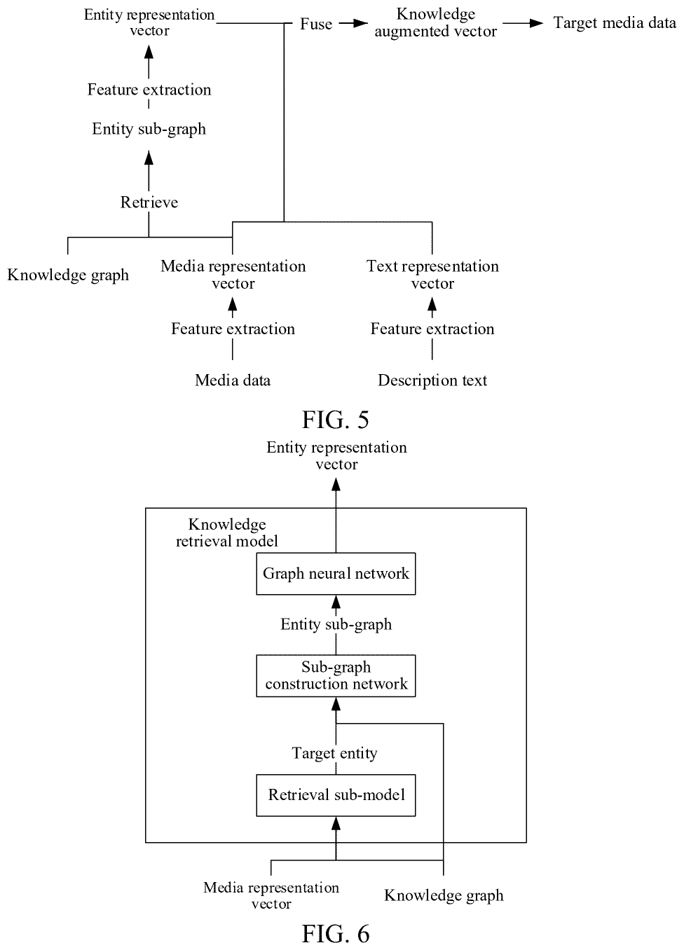

Exemplarily, as shown in FIG. 5, the server extracts the media representation vector of the media data, extracts the text representation vector of the description text of the media data, retrieves in the knowledge graph according to the media representation vector, to obtain the entity sub-graph, and determines the entity representation vector of the entity sub-graph. The server fuses the media representation vector, the text representation vector, and the entity representation vector to obtain the knowledge augmented vector, obtains the target media data based on the knowledge augmented vector, and recommends the target media data to the target object.

In the media data recommendation method, the media representation vector and the text representation vector are extracted from the media data and the description text of the media data; the entity sub-graph is retrieved from the knowledge graph according to the media representation vector, and the entity representation vector of the entity sub-graph is determined; feature fusion processing is performed on the media representation vector, the text representation vector, and the entity representation vector to obtain the knowledge augmented vector; and the target media data is recommended to the target object based on the knowledge augmented vector. The entity sub-graph related to the content of the media data is retrieved from the knowledge graph by using the media representation vector, so that the entity representation vector related to the content of the media data may be obtained based on the entity sub-graph. The media representation vector, the text representation vector, and the entity representation vector are fused to obtain the knowledge augmented vector, so that the knowledge augmented vector can reflect the content of the media data and the description text, and entity information related to the content of the media data. Therefore, the target media data whose content is similar to that of the media data and whose entity is related to that of the media data may be obtained based on the knowledge augmented vector, thereby improving correlation between the target media data and the media data. Therefore, the target media data may be media data in which the target object is interested, thereby improving media recommendation. In this way, the target object can browse the media data in which the target object is interested without performing manual search, thereby reducing resource consumption caused by manual search and improving resource utilization.

In some embodiments, the performing knowledge retrieval in a knowledge graph according to the media representation vector, to obtain an entity sub-graph of the media data, and determining an entity representation vector of the entity sub-graph includes: retrieving, based on the media representation vector, target entities related to the media data from the knowledge graph; determining the entity sub-graph of the media data based on the target entities and the knowledge graph; and extracting features of a plurality of entities in the entity sub-graph, to obtain the entity representation vector.

The target entities are some entities in the knowledge graph that are related to the content of the media data, and may also be understood as entities of the media data. Exemplarily, the media data is an image, and content of the image is that a baseball player throws a ball on a playing field. In this case, the target entity may include but is not limited to: baseball, player, throws a ball, and playing field.

The entity representation vector includes entity representation sub-vectors of a plurality of entities in the entity sub-graph.

In some embodiments, the server obtains a plurality of initial entity vectors in the knowledge graph, determines correlation degrees between the media representation vector and the plurality of initial entity vectors, selects a candidate correlation degree from the correlation degrees between the media representation vector and the plurality of initial entity vectors, and uses, as the target entity related to the media data, an entity represented by an initial entity vector used for calculating the candidate correlation degree.

The selecting the candidate correlation degree from the correlation degrees between the media representation vector and the plurality of initial entity vectors may be: sorting the correlation degrees between the media representation vector and the plurality of initial entity vectors in descending order, to obtain an initial correlation degree sequence, and selecting a third preset quantity of candidate correlation degrees that are sorted in front in the initial correlation degree sequence.

In some embodiments, the determining an entity sub-graph of the media data based on the target entities and the knowledge graph may be: determining a relationship between the target entities according to the knowledge graph, and determining the entity sub-graph according to the target entities and the relationship between the target entities.

The server extracts features of the entity sub-graph, to obtain entity representation sub-vectors of a plurality of entities in the entity sub-graph, and determines an entity feature representation vector according to the entity representation sub-vectors of the plurality of entities in the entity sub-graph.

In the foregoing embodiment, the target entities related to the media data are retrieved from the knowledge graph by using the media representation vector, and the entity sub-graph of the media entity is then determined according to the target entities. Because the entity sub-graph includes the target entities and the relationship between the target entities, by determining the entity representation vector according to the entity sub-graph, the entity representation vector can more accurately reflect entities in the media data, thereby improving accuracy of the entity representation vector.

In some embodiments, the media representation vector includes at least two image representation sub-vectors; and the retrieving, based on the media representation vector, target entities related to the media data from the knowledge graph includes: obtaining initial entity vectors of a plurality of entities in the knowledge graph; retrieving candidate entities from the knowledge graph according to the plurality of initial entity vectors and the at least two image representation sub-vectors; and selecting the target entities related to the media data from the candidate entities.

The initial entity vectors are representation vectors of a plurality of entities in the knowledge graph. The initial entity vector may be predetermined by an encoder.

When the media data is an image, the media representation vector is obtained by extracting features of at least two image blocks obtained by dividing the image. In this case, at least two image representation sub-vectors are used to represent the at least two image blocks. When the media data is a video, the media representation vector is obtained by extracting features of at least two image frames in the video. In this case, at least two image representation sub-vectors are used to represent the at least two image frames.

In some embodiments, for each initial entity vector, a correlation degree between the initial entity vector and each image representation sub-vector is determined, and a candidate entity is determined according to the correlation degree between the initial entity vector and each image representation sub-vector.

The determining a candidate entity according to the correlation degree between the initial entity vector and each image representation sub-vector may be: determining whether the correlation degree between the initial entity vector and each image representation sub-vector includes at least one correlation degree that falls within a preset interval, and if yes, determining that an entity represented by the initial entity vector is a candidate entity; or if not, determining that the entity represented by the initial entity vector is not a candidate entity.

A correlation degree that falls within the preset interval is greater than a correlation degree that does not fall within the preset interval. The preset interval may be set according to an actual requirement. A specific range of the preset interval is not limited in this embodiment of this disclosure.

In some embodiments, for each image representation sub-vector, a correlation degree between the image representation sub-vector and each initial entity vector is determined, and a candidate entity is determined according to the correlation degree between the image representation sub-vector and each initial entity vector.

The determining a candidate entity according to the correlation degree between the image representation sub-vector and each initial entity vector may be: determining a correlation degree set of the image representation sub-vector according to the correlation degree between the image representation sub-vector and each initial entity vector; selecting a plurality of relatively high correlation degrees from the correlation degree set of the image representation sub-vector; using, as an initial entity vector related to the image representation sub-vector, an initial entity vector used for calculating a relatively high correlation degree; and using, as the candidate entity related to the image representation sub-vector, an entity represented by the initial entity vector related to the image representation sub-vector.

The selecting relatively high correlation degrees from the correlation degree set of the image representation sub-vector may be: selecting a fourth preset quantity of correlation degrees from the correlation degree set in descending order of the correlation degrees. The fourth preset quantity can be set according to actual needs, and a specific value of the fourth preset quantity is not limited in this embodiment of the disclosure.

In some embodiments, the candidate entity is obtained through retrieval according to at least two image representation sub-vectors. The selecting a target entity related to the media data from the candidate entities may be: obtaining at least one target entity from the candidate entities retrieved according to each image representation sub-vector, to obtain the target entity related to the media data. The obtaining at least one target entity from the candidate entities retrieved according to each image representation sub-vector may be: determining a candidate correlation degree between a candidate entity and the image representation sub-vector, and obtaining at least one target entity from the candidate entities according to the candidate correlation degree. A candidate correlation degree between the target entity and the image representation sub-vector is greater than a candidate correlation degree between another candidate entity and the image representation sub-vector.

In some embodiments, the candidate entity is obtained through retrieval according to at least two image representation sub-vectors. The selecting a target entity related to the media data from the candidate entities may be: selecting at least one target entity from all candidate entities retrieved according to at least two image representation sub-vectors. For example, a candidate entity is retrieved according to each image representation sub-vector, and a correlation degree between the image representation sub-vector and the candidate entity is used as a candidate correlation degree of the candidate entity. The server sorts, in descending order of the candidate correlation degrees, all the candidate entities retrieved according to the at least two image representation sub-vectors, to obtain a candidate entity sequence, selects, from the candidate entity sequence, a fifth preset quantity of candidate entities sorted in front, and uses the fifth preset quantity of candidate entities as the target entities related to the media data. The fifth preset quantity can be set according to actual needs, and a specific value of the fifth preset quantity is not limited in this embodiment of the disclosure.

In the foregoing embodiment, the candidate entities related to the image representation sub-vector are retrieved from the knowledge graph according to the initial entity vector and the at least two image representation sub-vectors in the knowledge graph, and the target entity related to the media data is selected from the candidate entities related to the image representation sub-vector, so that the determined target entity is related to a plurality of image representation sub-vectors of the media data. Therefore, the target entity can reflect content of the media data, thereby improving accuracy of retrieving the target entity related to the media data.

In some embodiments, the retrieving candidate entities from the knowledge graph according to the plurality of initial entity vectors and the at least two image representation sub-vectors includes: determining a correlation degree set of the at least two image representation sub-vectors according to the plurality of initial entity vectors and the at least two image representation sub-vectors, where the correlation degree set includes correlation degrees between the image representation sub-vectors and initial entity vectors; and selecting, according to the correlation degree set, candidate entities related to the at least two image representation sub-vectors from the knowledge graph.

The candidate entities related to the at least two image representation sub-vectors include a candidate entity related to each image representation sub-vector.

In some embodiments, for each image representation sub-vector, the server determines correlation degrees between the image representation sub-vector and a plurality of initial entity vectors, and determines a correlation degree set of the image representation sub-vector according to the correlation degrees between the image representation sub-vector and the plurality of initial entity vectors.

Exemplarily, the determining the correlation degree between the image representation sub-vector and the initial entity vector is shown in formula (1).

$$sim ( {v}_{i} , {m}_{j} ) = {{f}_{v} ( {v}_{i} )}^{T} {f}_{e} ( {m}_{j} ) . \qquad formula ( 1 )$$

fᵥ(vᵢ) is an image representation sub-vector, fᵥ(vᵢ)^{T} is a transposed vector of the image representation sub-vector, fₑ(mⱼ) is an initial entity vector, and sim(vᵢ, mⱼ) is a correlation degree between the image representation sub-vector and the initial entity vector.

The server sorts the plurality of correlation degrees in the correlation degree set in descending order, selects, from the sorted correlation degree set, a sixth preset quantity of target correlation degrees sorted in front, obtains initial entity representation vectors of the sixth preset quantity of target correlation degrees, and uses, as candidate entities related to the image representation sub-vector, entities represented by the obtained plurality of initial entity representation vectors.

Exemplarily, assuming that the media representation vector includes s image representation sub-vectors and the sixth preset quantity is t, s*t candidate entities may be obtained.

In the foregoing embodiment, a relatively high correlation degree is obtained from the correlation degree set of each image representation sub-vector, and the candidate entity related to the image representation sub-vector is selected according to the relatively high correlation degree, so that the candidate entity can reflect content represented by the image representation sub-vector, thereby improving accuracy of the selected candidate entity.

In some embodiments, the determining the entity sub-graph of the media data based on the target entities and the knowledge graph includes: determining a neighboring node of each target entity in the knowledge graph; determining extended entities according to the plurality of target entities and the neighboring node of each target entity, and determining a relationship between the extended entities in the knowledge graph; and determining the entity sub-graph of the media data according to the extended entities and the relationship between the extended entities.

The neighboring node of the target entity may be a first-order neighboring node of the target entity, or may include a first-order neighboring node and a second-order neighboring node of the target entity. The extended entity includes the target entity and an entity represented by the neighboring node.

Exemplarily, entities included in the knowledge graph may be indicated as: {E1, E2, . . . , En}, a plurality of target entities {E1, E2, . . . , Eq} related to the media data are retrieved from {E1, E2, . . . , En} according to the media representation vector V, first-order neighboring nodes of the plurality of target entities are determined in the knowledge graph, to extend the target entities to obtain extended entities {E1, E2, . . . , Eu}, and an entity sub-graph G is constructed according to the extended entities {E1, E2, . . . , Eu} in the knowledge graph.

In the foregoing embodiment, the neighboring nodes of the target entities are obtained from the knowledge graph to extend the target entities, so that the entity sub-graph includes more diverse entities, thereby improving quality of the entity representation vector of the entity sub-graph.

In some embodiments, the retrieving, based on the media representation vector, a plurality of target entities related to the media data from the knowledge graph includes: retrieving, based on the media representation vector by using a retrieval sub-model of a knowledge retrieval model, the plurality of target entities related to the media data from the knowledge graph; the determining the entity sub-graph of the media data based on the target entities and the knowledge graph includes: determining the entity sub-graph of the media data based on the plurality of target entities and the knowledge graph by using a sub-graph construction network of the knowledge retrieval model; and the extracting features of a plurality of entities in the entity sub-graph, to obtain the entity representation vector includes: extracting the features of the plurality of entities in the entity sub-graph by using a graph neural network of the knowledge retrieval model, to obtain the entity representation vector.

The knowledge retrieval model includes a retrieval sub-model, a sub-graph construction network, and a graph neural network. As shown in FIG. 6, the server inputs the media representation vector and the knowledge graph to the retrieval sub-model, to obtain the target entities related to the media data through retrieval by using the retrieval sub-model. The target entity and the knowledge graph are inputted to a sub-graph construction network, and the entity sub-graph of the media data is outputted by using the sub-graph construction network. The entity sub-graph is inputted to the graph neural network, and features of a plurality of entities in the entity sub-graph are extracted by using the graph neural network, to obtain the entity representation vector.

In some embodiments, the retrieval sub-model may encode the plurality of entities in the knowledge graph, to obtain initial entity vectors of the plurality of entities; determine, according to the initial entity vectors and the plurality of image representation sub-vectors in the media representation vector, a correlation degree set of the plurality of image representation sub-vectors; select, based on the correlation degree set, candidate entities related to the plurality of image representation sub-vectors from the knowledge graph; and select, from the plurality of candidate entities, the plurality of target entities related to the media data.

The target entity and the knowledge graph are inputted to a sub-graph construction network. The sub-graph construction network may obtain a neighboring node of the target entity from the knowledge graph, determine extended entities according to the target entity and the neighboring node, determine a relationship between the extended entities in the knowledge graph, and determine an entity sub-graph according to the extended entities and the relationship between the extended entities.

For each entity in the entity sub-graph, random wandering is performed in the entity sub-graph according to the entity, to obtain a node track graph of the entity, the node track graph is inputted to the graph neural network, and a representation vector of the entity is outputted by using the graph neural network. A representation vector of each entity in the entity sub-graph is determined in the same manner, and the entity representation vector is obtained according to the representation vector of each entity. In an actual application, the graph neural network may be a graph neural network (GNN).

In the foregoing embodiment, the retrieval sub-model, the sub-graph construction network, and the graph neural network in the knowledge retrieval model are used to retrieve the target entity related to the media data, construct the entity sub-graph of the media data, and extract the entity representation vector of the plurality of entities in the entity sub-graph, so that the entity representation vector can more accurately reflect the entities in the media data, thereby improving the accuracy of the entity representation vector.

In some embodiments, the performing feature fusion processing on the media representation vector, the text representation vector, and the entity representation vector, to obtain a knowledge augmented vector includes: concatenating the media representation vector, the text representation vector, and the entity representation vector, and adding a separation element between the media representation vector and the text representation vector and adding a separation element between the text representation vector and the entity representation vector during the concatenating, to obtain a concatenated vector; and performing feature fusion processing on the concatenated vector by using a knowledge augmented model, to obtain the knowledge augmented vector.

The knowledge augmented model includes a regularization layer, an encoder, and a feedforward network layer.

The separation element in the concatenated vector may be used for distinguishing the media representation vector, the text representation vector, and the entity representation vector in the concatenated vector.

The knowledge augmented vector includes: a media augmented vector, a text augmented vector, and an entity augmented vector. When the concatenated vector includes a separation element, the knowledge augmented vector also includes a separation element for distinguishing the media augmented vector, the text augmented vector, and the entity augmented vector.

In some embodiments, the media representation vector is {v1, v2, . . . , vn}, the text representation vector is {t1, t2, . . . , tn}, and the entity representation vector is {e1, e2, . . . , en}. The server concatenates the media representation vector, the text representation vector, and the entity representation vector, and adds a separation element [sep] between the media representation vector and the text representation vector and between the text representation vector and the entity representation vector during the concatenating, to obtain a concatenated vector {v1, v2, . . . , vn [sep] t1, t2, . . . , tn [sep] e1, e2, . . . , en}.

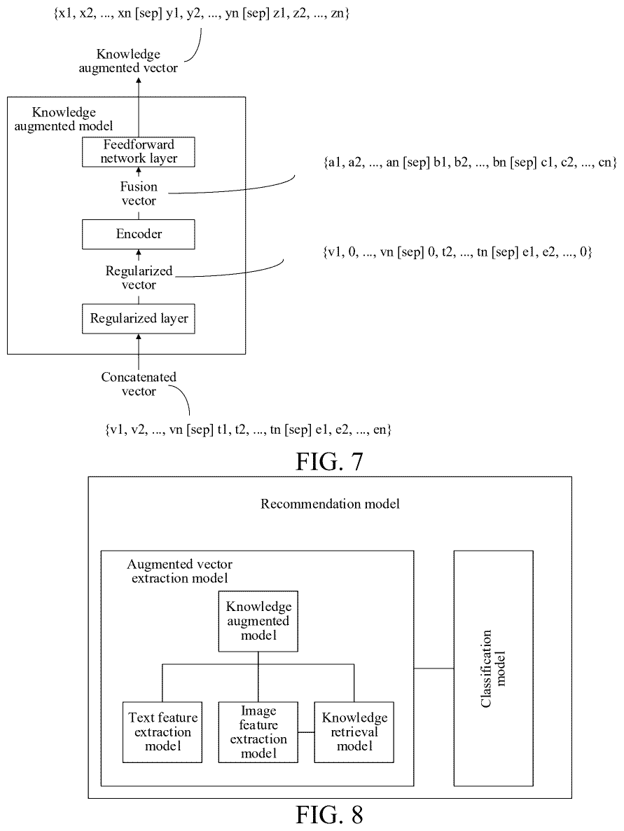

In some embodiments, as shown in FIG. 7, the server inputs the concatenated vector into the knowledge augmented model, and randomly discards the concatenated vector by using a regularization layer, to reduce a processed data volume to obtain a regularized vector. For example, the concatenated vector {v1, v2, . . . , vn [sep] t1, t2, . . . , tn [sep] e1, e2, . . . , en} is processed by using the regularization layer, to obtain a regularized vector {v1, 0, . . . , vn [sep] 0, t2, . . . , tn [sep] e1, e2, . . . , 0}.

The regularized vector is processed by using an encoder, to implement multimodal fusion on the media representation vector, the text representation vector, and the entity representation vector in the regularized vector, to obtain a fusion vector. In an actual application, the encoder may be implemented by using a multi-head attention network. For example, the encoder performs multimodal fusion on the regularized vector {v1, 0, . . . , vn [sep] 0, t2, . . . , tn [sep] e1, e2, . . . , 0}, to obtain a fusion vector {a1, a2, . . . , an [sep] b1, b2, . . . , bn [sep] c1, c2, . . . , cn}.

Activation processing is performed on the fusion vector by using a feedforward network layer, to obtain a knowledge augmented vector. Compared with the fusion vector, the knowledge augmented vector augments representation of the media data, the description text, and entities. For example, activation and fusion are performed on the fusion vector {a1, a2, . . . , an [sep] b1, b2, . . . , bn [sep] c1, c2, . . . , cn} by using a feedforward network layer, to obtain a knowledge augmented vector {x1, x2, . . . , xn [sep] y1, y2, . . . , yn [sep] z1, z2, . . . , zn}.

The knowledge augmented vector includes a media augmented vector {x1, x2, . . . , xn}, a text augmented vector {y1, y2, . . . , yn}, and an entity augmented vector {z1, z2, . . . , zn}.

In the foregoing embodiment, the media representation vector, the text representation vector, and the entity representation vector are concatenated to obtain the concatenated vector. Feature fusion is performed on the concatenated vector by using the knowledge augmented model to obtain the knowledge augmented vector. Multimodal representation vectors are fused, so that the knowledge augmented vector can reflect the content of the media data and the description text and the entity information related to the content of the media data. Therefore, the target media data whose content is similar to that of the media data and whose entity is related to that of the media data can be obtained based on the knowledge augmented vector, thereby improving media recommendation. In this way, the target object can browse the media data in which the target object is interested without performing manual search, thereby reducing resource consumption caused by manual search and improving resource utilization.

In some embodiments, the media data recommendation method further includes: extracting a first media training vector and a first text training vector from first sample media data and a first sample text of the first sample media data based on a feature extraction model; performing knowledge retrieval processing on the first media training vector and a knowledge graph based on a knowledge retrieval model, to obtain a training sub-graph of the first sample media data, and determining an entity training vector of the training sub-graph; performing feature fusion processing on the first media training vector, the first text training vector, and the entity training vector based on a knowledge augmented model, to obtain a knowledge augmented training vector; determining a visual loss value and a language loss value according to the knowledge augmented training vector and a sample label of the first sample media data; determining a knowledge retrieval loss value according to the knowledge augmented training vector and the training sub-graph; adjusting parameters of the feature extraction model, the knowledge retrieval model, and the knowledge augmented model based on the visual loss value, the language loss value, and the knowledge retrieval loss value, to obtain an augmented vector extraction model; and determining a recommendation model based on the augmented vector extraction model and a classification model, the recommendation model being configured for extracting a knowledge augmented vector according to media data, a description text, and the knowledge graph, and determining an interest type based on the knowledge augmented vector, to obtain target media data based on the interest type and recommend the target media data to a target object.

In some embodiments, the media data recommendation method may be applied to a recommendation model. As shown in FIG. 8, the recommendation model includes: an augmented vector extraction model and a classification model. The augmented vector extraction model includes: an image feature extraction model, a text feature extraction model, a knowledge retrieval model, and a knowledge augmented model. The augmented vector extraction model is obtained by performing parameter adjustment on the feature extraction model, the knowledge retrieval model, and the knowledge augmented model that have not been trained. The feature extraction model that has not been trained includes: an image feature extraction model and a text feature extraction model that have not been trained.

In an actual application, the media data, the description text, and the knowledge graph are processed by using the augmented vector model in the recommendation model, to obtain the knowledge augmented vector. The knowledge augmented vector is classified by using the classification model in the recommendation model, to obtain the interest type of the target object, so that the target media data is obtained based on the interest type and the target media data is recommended to the target object.

In some embodiments, the knowledge augmented training vector includes a media augmented training vector and a text augmented training vector, and the sample label includes a masked sub-image label and a masked word label; and the determining a visual loss value and a language loss value according to the knowledge augmented training vector and a sample label of the first sample media data includes: obtaining a masked sub-image augmented vector in the media augmented training vector, and determining the visual loss value according to the masked sub-image augmented vector and the masked sub-image label; and performing classification processing on the text augmented training vector to obtain a masked word prediction probability, and determining the language loss value based on the masked word prediction probability and the masked word label.

In some embodiments, the knowledge augmented training vector further includes an entity augmented training vector; and the determining a knowledge retrieval loss value according to the knowledge augmented training vector and the training sub-graph includes: obtaining a positive entity sample pair from the training sub-graph, and determining a first score of the positive entity sample pair according to the entity augmented training vector; obtaining a negative entity sample pair from the training sub-graph, and determining a second score of the negative entity sample pair, where the negative entity sample pair includes two training entities that have no entity relationship in the training sub-graph; and determining the knowledge retrieval loss value based on the first score and the second score.

In some embodiments, the first sample media data and first sample text belong to a sample set, and the sample set further includes second sample media data and a second sample text; and the method further includes: extracting features of the second sample media data and the second sample text, to obtain a second media training vector and a second text training vector; and determining an image text comparison loss value according to the second media training vector, the second text training vector, the first media training vector, and the first text training vector; and the adjusting parameters of the feature extraction model, the knowledge retrieval model, and the knowledge augmented model based on the visual loss value, the language loss value, and the knowledge retrieval loss value, to obtain an augmented vector extraction model includes: adjusting the parameters of the feature extraction model, the knowledge retrieval model, and the knowledge augmented model based on the visual loss value, the language loss value, the knowledge retrieval loss value, and the image text comparison loss value, to obtain the augmented vector extraction model.

In some embodiments, the determining an image text comparison loss value according to the second media training vector, the second text training vector, the first media training vector, and the first text training vector includes: determining a first similarity degree according to the first media training vector and the second text training vector; determining a second similarity degree according to the first text training vector and the second media training vector; and determining the image text comparison loss value according to the first similarity degree, the second similarity degree, a first similarity degree label, and a second similarity degree label.

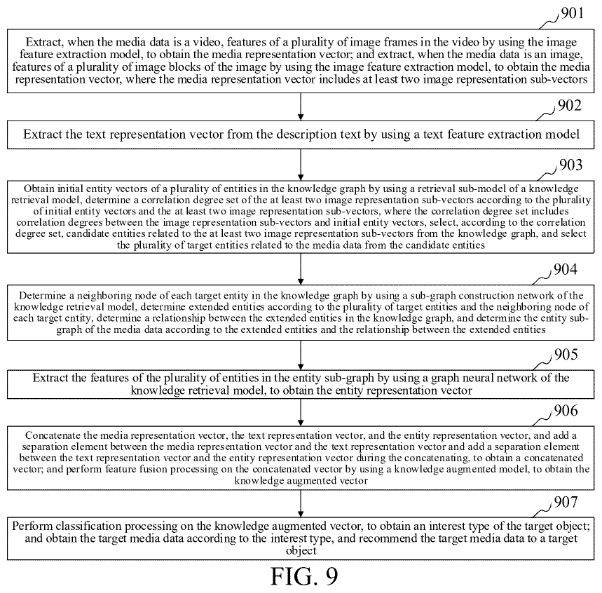

In some embodiments, as shown in FIG. 9, the media data recommendation method includes:

Operation 901: Extract, when the media data is a video, features of a plurality of image frames in the video by using the image feature extraction model, to obtain the media representation vector; and extract, when the media data is an image, features of a plurality of image blocks of the image by using the image feature extraction model, to obtain the media representation vector, where the media representation vector includes at least two image representation sub-vectors.

Operation 902: Extract the text representation vector from the description text of the media data by using a text feature extraction model.

Operation 903: Obtain initial entity vectors of a plurality of entities in the knowledge graph by using a retrieval sub-model of a knowledge retrieval model, determine a correlation degree set of the at least two image representation sub-vectors according to the plurality of initial entity vectors and the at least two image representation sub-vectors, where the correlation degree set includes correlation degrees between the image representation sub-vectors and initial entity vectors, select, according to the correlation degree set, candidate entities related to the at least two image representation sub-vectors from the knowledge graph, and select the plurality of target entities related to the media data from the candidate entities.

Operation 904: Determine a neighboring node of each target entity in the knowledge graph by using a sub-graph construction network of the knowledge retrieval model, determine extended entities according to the plurality of target entities and the neighboring node of each target entity, determine a relationship between the extended entities in the knowledge graph, and determine the entity sub-graph of the media data according to the extended entities and the relationship between the extended entities.

Operation 905: Extract the features of the plurality of entities in the entity sub-graph by using a graph neural network of the knowledge retrieval model, to obtain the entity representation vector.

Operation 906: Concatenate the media representation vector, the text representation vector, and the entity representation vector, and add a separation element between the media representation vector and the text representation vector and add a separation element between the text representation vector and the entity representation vector during the concatenating, to obtain a concatenated vector; and perform feature fusion processing on the concatenated vector by using a knowledge augmented model, to obtain the knowledge augmented vector.

Operation 907: Perform classification processing on the knowledge augmented vector, to obtain an interest type of the target object; and obtain the target media data according to the interest type, and recommend the target media data to a target object.

In the media data recommendation method, the media representation vector and the text representation vector are extracted from the media data and the description text of the media data; the entity sub-graph is retrieved from the knowledge graph according to the media representation vector, and the entity representation vector of the entity sub-graph is determined; feature fusion processing is performed on the media representation vector, the text representation vector, and the entity representation vector to obtain the knowledge augmented vector; and the target media data is recommended to the target object based on the knowledge augmented vector.

The entity sub-graph related to the content of the media data is retrieved from the knowledge graph by using the media representation vector, so that the entity representation vector related to the content of the media data may be obtained based on the entity sub-graph. The media representation vector, the text representation vector, and the entity representation vector are fused to obtain the knowledge augmented vector, so that the knowledge augmented vector can reflect the content of the media data and the description text, and entity information related to the content of the media data. Therefore, the target media data whose content is similar to that of the media data and whose entity is related to that of the media data may be obtained based on the knowledge augmented vector, thereby improving correlation between the target media data and the media data. Therefore, the target media data may be media data in which the target object is interested, thereby improving media recommendation. In this way, the target object can browse the media data in which the target object is interested without performing manual search, thereby reducing resource consumption caused by manual search and improving resource utilization.

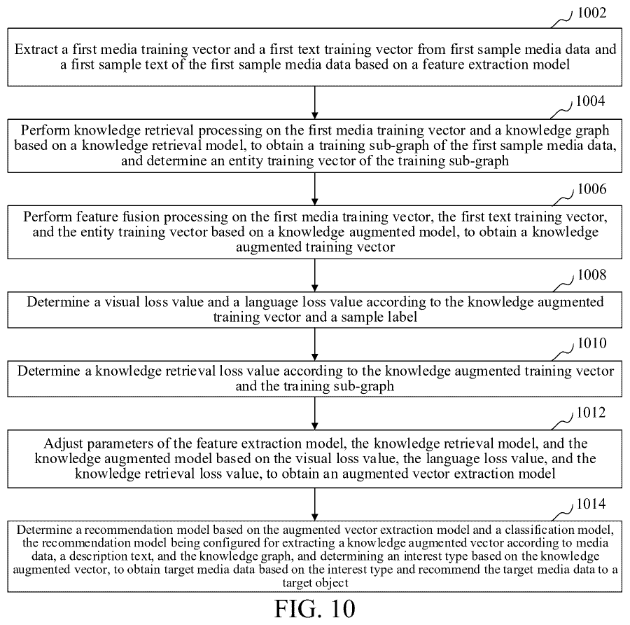

In some embodiments, as shown in FIG. 10, a recommendation model processing method is provided. The method may be performed by a server or a terminal. For example, the method is performed by a server. The method includes the following operations:

Operation 1002: Extract a first media training vector and a first text training vector from first sample media data and a first sample text of the first sample media data based on a feature extraction model.

The feature extraction model includes an image feature extraction model and a text feature extraction model that have not been trained.

In some embodiments, feature extraction is performed on the first sample media data by using the image feature extraction model that has not been trained, to obtain a first media training vector, and feature extraction is performed on the first sample text by using the text feature extraction model that has not been trained, to obtain a first text training vector.

In some embodiments, the image feature extraction model that has not been trained may be implemented by using a first bidirectional encoding model (Transformer), and the first bidirectional encoding model includes a plurality of image encoders. The first sample media data includes a plurality of sample images and masked sub-images. The initial sample image may be divided to obtain a plurality of sample images, and some of the plurality of sample images are masked, to obtain the first media sample data including a plurality of sample images and masked sub-images. Alternatively, image frames in a sample video may be sampled, to obtain a plurality of sample images, and some of the plurality of sample images are masked, to obtain the first media sample data.

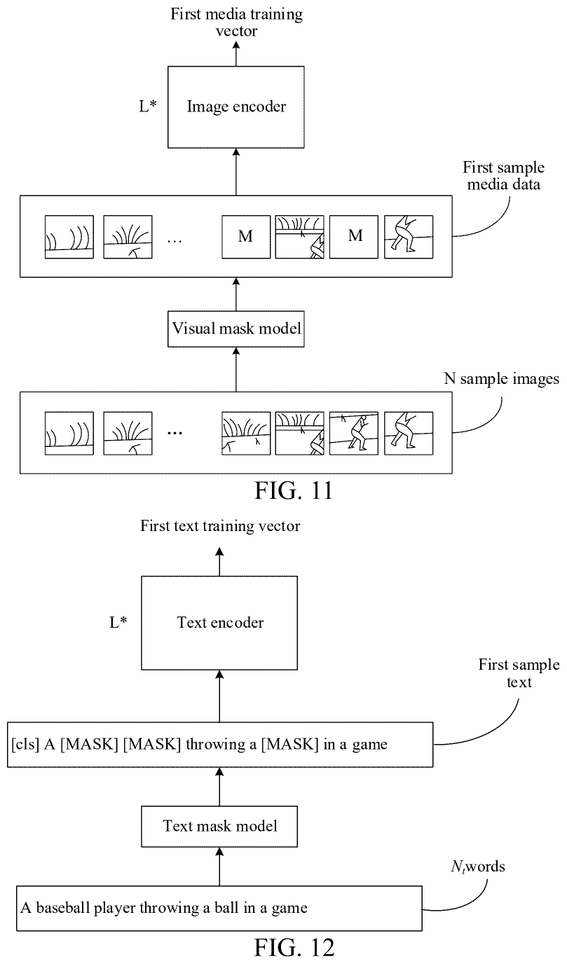

Exemplarily, as shown in FIG. 11, an initial sample image is divided into N sample images, and masking processing is performed on the N sample images by using a visual mask model, to mask some of the N sample images to obtain the first sample media data. The first bidirectional encoding model includes L image encoders, and the first sample media data is processed by using the L image encoders, to obtain the first media training vector.

In some embodiments, the text feature extraction model that has not been trained may be implemented by using a second bidirectional encoding model, and the second bidirectional encoding model includes a plurality of text encoders. The first sample text includes a plurality of words and a masked word. Word segmentation processing may be performed on the initial sample text to obtain a plurality of words, and some of the plurality of words are masked, to obtain the first sample text including the plurality of words and masked words.

Exemplarily, as shown in FIG. 12, word segmentation processing is performed on an initial sample, to obtain Nt words. For example, the initial sample is: “A baseball player throwing a ball in a game”, and the Nt words are respectively: “A”, “baseball”, “player”, “throwing”, “a”, “ball”, “in”, “a”, and “game”. Masking processing is performed on the Nt words by using a text mask model, to mask some of the Nt words, and a start mark is added before the sample text on which the masking processing has been performed, to obtain a first sample text. For example, the first sample text includes: “[cls]”, “A”, “[MASK]”, “[MASK]”, “throwing”, “a”, “[MASK]”, “in”, “a”, and “game”. The second bidirectional encoding model includes L text encoders, and the first sample text is processed by using the L text encoders, to obtain the first text training vector.

Operation 1004: Perform knowledge retrieval processing on the first media training vector and a knowledge graph based on a knowledge retrieval model, to obtain a training sub-graph of the first sample media data, and determine an entity training vector of the training sub-graph.

The knowledge retrieval model in this operation is a knowledge retrieval model that has not been trained, and the knowledge retrieval model that has not been trained includes: a retrieval sub-model that has not been trained, a sub-graph construction network that has not been trained, and a graph neural network that has not been trained.

In some embodiments, the first media training vector and the knowledge graph are processed by using the retrieval sub-model that has not been trained, to retrieve a training entity related to the first sample media data; the training entity and the knowledge graph are processed by using the sub-graph construction network that has not been trained, to construct a training sub-graph of the first sample media data; and feature extraction is performed on the training sub-graph by using the graph neural network that has not been trained, to obtain an entity training vector of the training sub-graph.

Operation 1006: Perform feature fusion processing on the first media training vector, the first text training vector, and the entity training vector based on a knowledge augmented model, to obtain a knowledge augmented training vector.

The knowledge augmented model in this operation is a knowledge augmented model that has not been trained, and the knowledge augmented model that has not been trained includes: a regularization layer that has not been trained, an encoder that has not been trained, and a feedforward layer that has not been trained.

In some embodiments, the server concatenates the first media training vector, the first text training vector, and the entity training vector, adds a separation element between the first media training vector and the first text training vector and between the first text training vector and the entity training vector during the concatenating, to obtain a concatenated training vector, and performs random discarding processing on the concatenated training vector by using the regularization layer that has not been trained, to obtain a regularized training vector. Fusion processing is performed on the regularized training vector by using an encoder that has not been trained, to perform multimodal fusion on the first media training vector, the first text training vector, and the entity training vector in the regularized training vector, to obtain a training fusion vector. Activation processing is performed on the training fusion vector by using a feedforward layer that has not been trained, to obtain the knowledge augmented training vector.

The knowledge augmented training vector includes a media augmented training vector, a text augmented training vector, and an entity augmented training vector.

In some embodiments, the encoder that has not been trained includes: a self-attention layer, a first normalization layer, a feedforward layer, and a second normalization layer. A process of processing the regularized training vector by the self-attention layer is shown in formula (2).

$${\hat{h}}_{i}^{( l + 1 )} = {\sum }_{m = 1}^{M} {W}_{m}^{( l + 1 )} ( {\sum }_{j = 1}^{N} {A}_{i , j}^{m} \cdot {V}_{m}^{( l + 1 )} {x}_{j}^{l} ) . \qquad formula ( 2 )$$

$${\hat{h}}_{i}^{( l + 1 )}$$

is a representation vector outputted by the self-attention layer, xⱼ^{l} is a regularized training vector, the self-attention layer includes a plurality of attention heads,

$${W}_{m}^{( l + 1 )}$$

is a parameter of an mth attention head,

$${V}_{m}^{( l + 1 )}$$

is a value parameter of the mth attention head,

$${A}_{i , j}^{m} = exp [ {( {Q}_{m}^{( l + 1 )} {x}_{i}^{l} )}^{T} ( {K}_{m}^{( l + 1 )} {x}_{j}^{l} ) ] , {Q}_{m}^{( l + 1 )}$$

is a query parameter of the mth attention head, and

$${K}_{m}^{( l + 1 )}$$

is a key parameter of the mth attention head.

A process of processing, by using the first normalization layer, the representation vector and the regularized training vector outputted by the self-attention layer is shown in formula (3).

$${h}_{i}^{( l + 1 )} = LayerNorm ( {x}_{i}^{l} + {\hat{h}}_{i}^{( l + 1 )} ) . \qquad formula ( 3 )$$

$${h}_{i}^{( l + 1 )}$$

is a representation vector outputted by the first normalization layer,

$${\hat{h}}_{i}^{( l + 1 )}$$

is a representation vector outputted by the self-attention layer, and xᵢ^{l} is a regularized training vector.

A process of processing, by using the feedforward layer, the representation vector outputted by the first normalization layer is shown in formula (4).

$${\hat{x}}_{i}^{( l + 1 )} = {F}_{2}^{( l + 1 )} \cdot GELU ( {F}_{1}^{( l + 1 )} {h}_{i}^{( l + 1 )} ) . \qquad formula ( 4 )$$

$${\hat{x}}_{i}^{( l + 1 )}$$

is a representation vector outputted by the feedforward layer,

$${F}_{1}^{( l + 1 )} and {F}_{2}^{( l + 1 )}$$

are network parameters of the feedforward layer, and hᵢ^{(l+1)} is a representation vector outputted by the first normalization layer.

A process of processing, by using the second normalization layer, the representation vector outputted by the feedforward layer and the representation vector outputted by the first normalization layer is shown in formula (5).

$${x}_{i}^{( l + 1 )} = LayerNorm ( {h}_{i}^{( l + 1 )} + {\hat{x}}_{i}^{( l + 1 )} ) . \qquad formula ( 5 )$$

$${x}_{i}^{( l + 1 )}$$

is a representation vector outputted by the second normalization layer, that is, the training fusion vector,

$${h}_{i}^{( l + 1 )}$$

is a representation vector outputted by the first normalization layer, and

$${\hat{x}}_{i}^{( l + 1 )}$$

is a representation vector outputted by the feedforward layer.

Operation 1008: Determine a visual loss value and a language loss value according to the knowledge augmented training vector and a sample label.

The sample label includes a masked sub-image label and a masked word label. The visual loss value is used for reflecting a difference between the media augmented training vector and the masked sub-image label. The language loss value is used for reflecting a difference between a prediction probability corresponding to the text augmented training vector and the masked word label.

In some embodiments, operation 1008 includes: obtaining a masked sub-image augmented vector in the media augmented training vector, and determining the visual loss value according to the masked sub-image augmented vector and the masked sub-image label; and performing classification processing on the text augmented training vector to obtain a masked word prediction probability, and determining the language loss value based on the masked word prediction probability and the masked word label.

The media augmented training vector includes a masked sub-image augmented vector of the masked sub-image. The masked sub-image augmented vector is an eigenvector obtained by reconstructing the masked sub-image by using the first sample media data, the first sample text, and the knowledge graph.

The text augmented training vector includes a masked word augmented vector of the masked word. The masked word augmented vector is an eigenvector obtained by predicting the masked word by using the first sample media data, the first sample text, and the knowledge graph.

In some embodiments, the server obtains a masked sub-image augmented vector in the media augmented training vector, obtains a masked sub-image label of the masked sub-image augmented vector, and calculates the visual loss value according to the masked sub-image augmented vector and the masked sub-image label of the masked sub-image augmented vector. The masked sub-image augmented vector and the masked sub-image label of the masked sub-image augmented vector correspond to the same masked sub-image.

Exemplarily, the visual loss value may be determined by using a cross entropy loss function, as shown in formula (6).

$${ℒ}_{MVM} = H ( {y ( I )}^{m s k} , {p ( I )}^{m s k} ) . \qquad formula ( 6 )$$

[symbol] _{MVM} is a visual loss value, y(l)^{msk} is a masked sub-image label, p(l)^{msk} is a masked sub-image augmented vector, and H(⋅) is a cross entropy loss function.

In some embodiments, when there are a plurality of masked sub-image augmented vectors, a loss value of each masked sub-image augmented vector may be determined based on the masked sub-image augmented vector and a corresponding masked sub-image label, and an average value is calculated according to loss values of the plurality of masked sub-image augmented vectors, to obtain the visual loss value.

In some embodiments, the server may perform classification processing on the text augmented training vector by using a classifier, to obtain a masked word prediction probability. The server obtains a masked word augmented vector in the text augmented training vector, and calculates the language loss value by using the masked word prediction probability and a masked word label. The masked word prediction probability and the masked word label correspond to the same masked word.

For example, the language loss value may be determined by using a cross entropy loss function, as shown in formula (7).

$${ℒ}_{M L M} = H ( {y ( T )}^{m s k} , {p ( T )}^{m s k} ) . \qquad formula ( 7 )$$

[symbol] _{MLM} is a language loss value, y(T)^{msk} is a masked word label, p(T)^{msk} is a masked word prediction probability, and H(⋅) is a cross entropy loss function.

In the foregoing embodiment, the visual loss value is determined through a task of predicting the representation vector of the masked sub-image, and the language loss value is determined through a task of predicting the representation vector of the masked word, thereby improving accuracy of the visual loss value and the language loss value, so as to facilitate subsequent adjustment of the model parameter by using the visual loss value and the language loss value.

Operation 1010: Determine a knowledge retrieval loss value according to the knowledge augmented training vector and the training sub-graph.

The knowledge augmented training vector includes an entity augmented training vector, and the entity augmented training vector includes a plurality of entity augmented sub-vectors.

In some embodiments, for each entity augmented sub-vector, the server may determine a target entity augmented sub-vector of the entity augmented sub-vector in other entity augmented sub-vectors, and determine a positive entity sample pair by using the entity augmented sub-vector and the target entity augmented sub-vector. The server obtains the negative entity sample pair from the training sub-graph, and the server determines the knowledge retrieval loss value according to the positive entity sample pair and the negative entity sample pair.

In some embodiments, operation 1010 includes: obtaining a positive entity sample pair from the training sub-graph, and determining a first score of the positive entity sample pair according to the entity augmented training vector; obtaining a negative entity sample pair from the training sub-graph, and determining a second score of the negative entity sample pair according to the entity augmented training vector, where the negative entity sample pair includes two training entities that have no entity relationship in the training sub-graph; and determining the knowledge retrieval loss value based on the first score and the second score.

Two entities in the positive entity sample pair have an entity relationship in the training sub-graph. Two entities in the negative entity sample pair have no entity relationship in the training sub-graph.

In some embodiments, the server obtains, from the training sub-graph, each positive entity sample pair having an entity relationship. For each positive entity sample pair, the server obtains, from the entity augmented training vector, entity augmented sub-vectors of two entities in the positive entity sample pair, and determines a first score of the positive entity sample pair according to the entity augmented sub-vectors of the two entities in the positive entity sample pair.

The server obtains, from the training sub-graph, each negative entity sample pair having no entity relationship. For each negative entity sample pair, the server obtains, from the entity augmented training vector, entity augmented sub-vectors of two entities in the negative entity sample pair, and determines a second score of the negative entity sample pair according to the entity augmented sub-vectors of the two entities in the negative entity sample pair.

For example, the training sub-graph includes entities E1, E2, E3, E4, and E5, where E2 and E3 have no entity relationship, and E4 and E5 have no entity relationship. In this case, the negative entity sample pair includes {E2, E3} and {E4, E5}, a second score of {E2, E3} is determined according to entity augmented sub-vectors of E2 and E3, and a second score of {E4, E5} is determined according to entity augmented sub-vectors of E4 and E5.

In some embodiments, the knowledge retrieval loss value may be determined according to the first score and the second score shown in formula (8).

$${ℒ}_{L i n k P r e d} = {\sum }_{( h , r , t ) ∈ S} - log σ ( {ϕ}_{r} ( h , t ) + γ ) + \frac{1}{n} {\sum }_{( {h}^{′} , r , {t}^{′} )} log σ ( {ϕ}_{r} ( {h}^{′} , {t}^{′} + γ ) ) . \qquad formula ( 8 )$$

[symbol] _{LinkPred} is a knowledge retrieval loss value, (h, t) is a positive entity sample pair, ϕᵣ(h, t) is a first score, (h′, t′) is a negative entity sample pair, ϕᵣ(h′, t′+γ) is a second score, ϕᵣ(⋅) is a scoring function, (h, r, t)∈S represents that an entity h and an entity t in a training sub-graph S have an entity relationship r, and γ is a preset parameter.

In some embodiments, the determining a knowledge retrieval loss value according to the knowledge augmented training vector and the training sub-graph includes: determining an entity sample pair according to the training sub-graph, determining a score of the entity sample pair according to the entity augmented training vector, when the score falls within a positive sample interval, using the entity sample pair as a positive entity sample pair, and when the score does not fall within the positive sample interval, using the entity sample pair as a negative entity sample pair.

Determining the entity sample pair according to the training sub-graph may be: combining every two entities included in the training sub-graph, to obtain each entity sample pair.

In the foregoing embodiment, the positive entity sample pair and the negative entity sample pair are determined by using the training sub-graph, and the first score of the positive entity sample pair and the second score of the negative entity sample pair are determined according to the entity augmented training vector, so that the knowledge retrieval loss value may be used for reflecting a difference between training entities having an entity relationship and training entities having no entity relationship, thereby improving accuracy of the knowledge retrieval loss value.

Operation 1012: Adjust parameters of the feature extraction model, the knowledge retrieval model, and the knowledge augmented model based on the visual loss value, the language loss value, and the knowledge retrieval loss value, to obtain an augmented vector extraction model.

The augmented vector extraction model includes: a feature extraction model that has been trained, a knowledge retrieval model that has been trained, and a knowledge augmented model that has been trained, where the feature extraction model that has been trained includes an image feature extraction model that has been trained and a text feature extraction model that has been trained.

In some embodiments, the server superimposes the visual loss value, the language loss value, and the knowledge retrieval loss value to obtain a total loss value, and adjusts, by using the total loss value, parameters of the feature extraction model that has not been trained, the knowledge retrieval model that has not been trained, and the knowledge augmented model that has not been trained, until the feature extraction model that has not been trained, the knowledge retrieval model that has not been trained, and the knowledge augmented model that has not been trained converge, to obtain an augmented vector extraction model.

In an actual application, parameter adjustment may be performed, according to a preset learning rate and a preset weight decay by using an AdamW optimizer, on the feature extraction model that has not been trained, the knowledge retrieval model that has not been trained, and the knowledge augmented model that has not been trained. The AdamW optimizer is configured to update a parameter of a neural network based on a gradient, so that the total loss value is minimized. The preset learning rate may be set according to an actual requirement. For example, the preset learning rate may be 5e-5. The preset weight decay may be set according to an actual requirement. For example, the preset weight decay may be 0.02.

Operation 1014: Determine a recommendation model based on the augmented vector extraction model and a classification model, the recommendation model being configured for extracting a knowledge augmented vector according to media data, a description text, and the knowledge graph, and determining an interest type based on the knowledge augmented vector, to obtain target media data based on the interest type and recommend the target media data to a target object.

The recommendation model includes an augmented vector extraction model and a classification model.

In some embodiments, the trained classification model is connected behind the augmented vector extraction model, to obtain the recommendation model. In an actual application, media data that is being browsed by the target object, the description text of the media data, and the knowledge graph are inputted to the recommendation model, the knowledge augmented vector is determined by using the augmented vector extraction model of the recommendation model, and the interest type of the knowledge augmented vector is outputted by the classification model of the recommendation model, so as to obtain the target media data according to the interest type and recommend the target media data to the target object.

The augmented vector extraction model may be a pre-trained model. After the augmented vector extraction model is obtained through pre-training, the augmented vector extraction model may be used in a downstream task of media data recommendation. A parameter of the augmented vector extraction model is fixed, a parameter of an initial classification model is adjusted, to obtain the trained classification model, and the recommendation model is determined according to the augmented vector extraction model and the trained classification model.

In the recommendation model processing method, the first media training vector and the first text training vector are extracted by using the feature extraction model, the entity training vector is retrieved from the knowledge graph according to the first media training vector, and feature fusion processing is performed on the first media training vector, the first text training vector, and the entity training vector, to obtain the knowledge augmented training vector, that is, an entity related to the first media sample data is retrieved from the knowledge graph, and the entity training vector of the related entity, the first media training vector, and the first text vector are fused, to implement multimodal data interaction. This augments representation of the first media sample data, the first text sample, and the related entity and improves quality of the knowledge augmented training vector. Parameters of the feature extraction model, the knowledge retrieval model, and the knowledge augmented model are adjusted jointly based on the visual loss value, the language loss value, and the knowledge retrieval loss value, so that in a parameter adjustment process, content information of the first media sample data and the first text sample can be learned, and entity information related to the first media sample data can also be learned, thereby improving quality of the augmented vector extraction model obtained through training, and further improving quality of the recommendation model including the augmented vector extraction model. The target media data recommended to the target object is determined based on the recommendation model, thereby improving media recommendation. In this way, the target object can browse the media data in which the target object is interested without performing manual search, thereby reducing resource consumption caused by manual search and improving resource utilization.

In some embodiments, the first sample media data and first sample text belong to a sample set, and the sample set further includes second sample media data and a second sample text; and The recommendation model processing method further includes: extracting features of the second sample media data and the second sample text, to obtain a second media training vector and a second text training vector; and determining an image text comparison loss value according to the second media training vector, the second text training vector, the first media training vector, and the first text training vector; and the adjusting parameters of the feature extraction model, the knowledge retrieval model, and the knowledge augmented model based on the visual loss value, the language loss value, and the knowledge retrieval loss value, to obtain an augmented vector extraction model includes: adjusting the parameters of the feature extraction model, the knowledge retrieval model, and the knowledge augmented model based on the visual loss value, the language loss value, the knowledge retrieval loss value, and the image text comparison loss value, to obtain the augmented vector extraction model.

The image text comparison loss value may reflect a difference between a similarity degree between sample media data and a sample text of the sample media data and a similarity degree between the sample media data and a sample text of other sample media data.

In some embodiments, the server may extract features of the second sample media data and the second sample text by using the feature extraction model, to obtain a second media training vector and a second text training vector. The server determines a first candidate similarity degree according to the first media training vector and the first text training vector, determines a second candidate similarity degree according to the first media training vector and the second text training vector, determines a third candidate similarity degree according to the first text training vector and the second media training vector, and determines an image text comparison loss value according to the first candidate similarity degree, the second candidate similarity degree, and the third candidate similarity degree.

In some embodiments, the server superimposes the visual loss value, the language loss value, the knowledge retrieval loss value, and the image text comparison loss value, to obtain a total loss value, and adjusts, by using the total loss value, parameters of the feature extraction model that has not been trained, the knowledge retrieval model that has not been trained, and the knowledge augmented model that has not been trained, until the feature extraction model that has not been trained, the knowledge retrieval model that has not been trained, and the knowledge augmented model that has not been trained converge, to obtain an augmented vector extraction model.

In the foregoing embodiment, parameters of the feature extraction model, the knowledge retrieval model, and the knowledge augmented model are adjusted jointly based on the visual loss value, the language loss value, the knowledge retrieval loss value, and the image text comparison loss value, so that in a parameter adjustment process, content information of the first media sample data and the first text sample can be learned, entity information related to the first media sample data can also be learned, and similar content between the first media sample data and the first text sample can also be learned, thereby improving quality of the augmented vector extraction model obtained through training, and further improving quality of the recommendation model including the augmented vector extraction model. The target media data recommended to the target object is determined based on the recommendation model, thereby improving media recommendation. In this way, the target object can browse the media data in which the target object is interested without performing manual search, thereby reducing resource consumption caused by manual search and improving resource utilization.

In some embodiments, the determining an image text comparison loss value according to the second media training vector, the second text training vector, the first media training vector, and the first text training vector includes: determining a first similarity degree according to the first media training vector and the second text training vector; determining a second similarity degree according to the first text training vector and the second media training vector; and determining the image text comparison loss value according to the first similarity degree, the second similarity degree, a first similarity degree label, and a second similarity degree label.

The first similarity degree label may be a similarity degree between the first media training vector and the second text training vector, and the second similarity degree label may be a similarity degree between the first text training vector and the second media training vector.

Exemplarily, the first similarity degree label may be y^{i2t}=S(I*T), the second similarity degree label may be y^{t2i}=S(T*I), I is a first media training vector, T is a first text training vector, S(⋅) is a similarity degree calculation function, and y^{i2t} may be a transposed form of y^{t2i}.

In some embodiments, the sample set includes a plurality of pieces of second media sample data, and correspondingly, the sample set includes a plurality of second sample texts. Therefore, there are a plurality of second media training vectors, and there are a plurality of second text training vectors. For the first media training vector, the server determines first similarity degrees between the first media training vector and the plurality of second text training vectors. For the first text training vector, the server determines second similarity degrees between the first text training vector and the plurality of second media training vectors.

The server determines a first target similarity degree according to the first similarity degrees between the first media training vector and the plurality of second text training vectors, and determines a second target similarity degree according to the second similarity degrees between the first text training vector and the plurality of second media training vectors.

Exemplarily, this is shown in formula (9):

$${s}^{( i 2 t )} = \frac{exp ( \frac{s ( {I}_{i} , {T}_{k} 〉}{τ} )}{{\sum }_{k \neq i}^{K} exp ( s 〈 {I}_{i} , {T}_{k} 〉 )} . \qquad formula ( 9 )$$

s^{(i2t)} is a first target similarity degree, s [symbol] Iᵢ, Tₖ [symbol] is a first similarity degree between a first media training vector Iᵢ and a kth second text training vector Tₖ, K is a quantity of sample texts in the sample set, and when k=i, Tᵢ is a first text training vector of the first media training vector Iᵢ.

Exemplarily, this is shown in formula (10):

$${s}^{( t 2 i )} = \frac{exp ( s 〈 {I}_{k} , {T}_{i} 〉 / τ )}{{\sum }_{k \neq i}^{K} exp ( s 〈 {I}_{k} , {T}_{i} 〉 )} . \qquad formula ( 10 )$$

s^{(t2i)} is a second target similarity degree, s [symbol] Iₖ, Tᵢ [symbol] is a second similarity degree between a first text training vector Tᵢ and a kth second media training vector Iₖ, K is a quantity of second media sample data in the sample set, and when k=i, Iᵢ is a first media training vector of the first text training vector Tᵢ.

The server may calculate a loss value between the first target similarity degree and the first similarity degree label by using a cross entropy loss function, calculate a loss value between the second target similarity degree and the second similarity degree label by using the cross entropy loss function, and determine the image text comparison loss value according to the loss value between the first target similarity degree and the first similarity degree label and the loss value between the second target similarity degree and the second similarity degree label. The image text comparison loss value is added to a model training process. By means of training, a similarity degree between the extracted representation vectors of the media data and the description text that have a correspondence is relatively large, and a similarity degree between the extracted representation vectors of the media data and the description text that have no correspondence is relatively small.

Exemplarily, this is shown in formula (11):

$${ℒ}_{ITC} = \frac{1}{2} ( [ H ( {y}^{i 2 t} , {s}^{i 2 t} ) + H ( {y}^{t 2 i} , {s}^{t 2 i} ) ) . \qquad formula ( 11 )$$

[symbol] _{ITC} is an image text comparison loss value, y^{i2t} is a first similarity degree label, s^{i2t} is a first target similarity degree, y^{t2i} is a second similarity degree label, and s^{t2i} is a second target similarity degree.

In the foregoing embodiment, the image comparison loss value is determined according to the first similarity degree, the second similarity degree, the first similarity degree label, and the second similarity degree label, and the image comparison loss value is added to the process of adjusting the parameters of the feature extraction model, the knowledge retrieval model, and the knowledge augmented model, to obtain the augmented vector extraction model through training, thereby improving quality of the augmented vector extraction model.

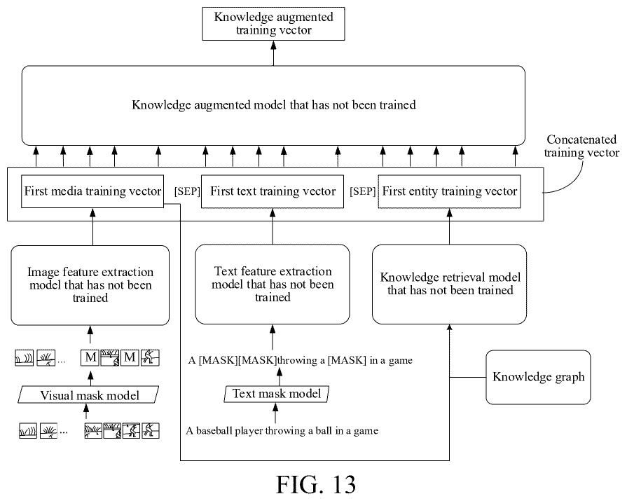

In some embodiments, as shown in FIG. 13, a training process of the augmented vector extraction model includes:

dividing an initial sample image into N sample images, and performing masking processing on the N sample images by using a visual mask model, to obtain the first sample media data; and processing first sample media data by using an image feature extraction model that has not been trained, to obtain a first media training vector;

performing word segmentation processing on an initial sample to obtain Nₜ words, performing masking processing on the Nₜ words by using a text mask model, and adding a start mark before a sample text on which the masking processing has been performed, to obtain a first sample text; and processing the first sample text by using a text feature extraction model that has not been trained, to obtain a first text training vector;

inputting the knowledge graph and the first media training vector to a knowledge retrieval model that has not been trained, and determining a training sub-graph and an entity training vector of the training sub-graph by using the knowledge retrieval model that has not been trained; where the knowledge retrieval model that has not been trained includes: a retrieval sub-model that has not been trained, a sub-graph construction network that has not been trained, and a graph neural network that has not been trained;

concatenating the first media training vector, the first text training vector, and the entity training vector, and adding a separation element between the first media training vector and the first text training vector and between the first text training vector and the entity training vector during the concatenating, to obtain a concatenated training vector;

performing feature fusion on the concatenated training vector by using the knowledge augmented model that has not been trained, to obtain the knowledge augmented training vector, where the knowledge augmented model that has not been trained includes: a regularization layer that has not been trained, an encoder that has not been trained, and a feedforward layer that has not been trained, and the knowledge augmented training vector includes a media augmented training vector, a text augmented training vector, and an entity augmented training vector; and

determining a visual loss value and a language loss value according to the knowledge augmented training vector and a sample label; determining a knowledge retrieval loss value according to the knowledge augmented training vector and the training sub-graph; and adjusting parameters of the feature extraction model, the knowledge retrieval model, and the knowledge augmented model based on the visual loss value, the language loss value, and the knowledge retrieval loss value, to obtain the augmented vector extraction model.

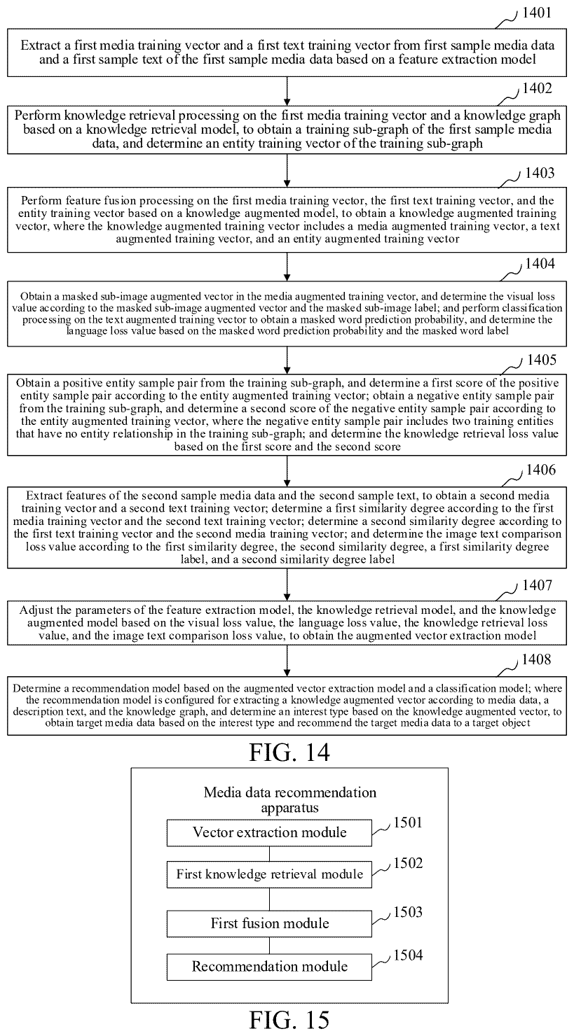

In some embodiments, as shown in FIG. 14, the recommendation model processing method includes:

Operation 1401: Extract a first media training vector and a first text training vector from first sample media data and a first sample text of the first sample media data based on a feature extraction model.

Operation 1402: Perform knowledge retrieval processing on the first media training vector and a knowledge graph based on a knowledge retrieval model, to obtain a training sub-graph of the first sample media data, and determine an entity training vector of the training sub-graph.

Operation 1403: Perform feature fusion processing on the first media training vector, the first text training vector, and the entity training vector based on a knowledge augmented model, to obtain a knowledge augmented training vector, where the knowledge augmented training vector includes a media augmented training vector, a text augmented training vector, and an entity augmented training vector.

Operation 1404: Obtain a masked sub-image augmented vector in the media augmented training vector, and determine the visual loss value according to the masked sub-image augmented vector and the masked sub-image label; and perform classification processing on the text augmented training vector to obtain a masked word prediction probability, and determine the language loss value based on the masked word prediction probability and the masked word label.

Operation 1405: Obtain a positive entity sample pair from the training sub-graph, and determine a first score of the positive entity sample pair according to the entity augmented training vector; obtain a negative entity sample pair from the training sub-graph, and determine a second score of the negative entity sample pair according to the entity augmented training vector, where the negative entity sample pair includes two training entities that have no entity relationship in the training sub-graph; and determine the knowledge retrieval loss value based on the first score and the second score.

Operation 1406: Extract features of the second sample media data and the second sample text, to obtain a second media training vector and a second text training vector; determine a first similarity degree according to the first media training vector and the second text training vector; determine a second similarity degree according to the first text training vector and the second media training vector; and determine the image text comparison loss value according to the first similarity degree, the second similarity degree, a first similarity degree label, and a second similarity degree label.

Operation 1407: Adjust parameters of the feature extraction model, the knowledge retrieval model, and the knowledge augmented model based on the visual loss value, the language loss value, the knowledge retrieval loss value, and the image text comparison loss value, to obtain an augmented vector extraction model.

Operation 1408: Determine a recommendation model based on the augmented vector extraction model and a classification model, the recommendation model being configured for extracting a knowledge augmented vector according to media data, a description text, and the knowledge graph, and determining an interest type based on the knowledge augmented vector, to obtain target media data based on the interest type and recommend the target media data to a target object.

In some embodiments, quality of the augmented vector extraction model is detected, and the augmented vector extraction model is compared with another model in a related technology. A comparison result is shown in Table 1.

TABLE 1

| Task | Data set | Model | Source of knowledge graph | Accuracy | |
|---|---|---|---|---|---|
| Knowledge- | OK-VQA | KAT | Wikidata + Frozen GPT-3 | 53.1 | |
| based | | REVIVE | Wikidata + Frozen GPT-3 | 56.6 | |
| downstream | | ALBEF | # image 12M | 54.7 | |
| task | | BLIP | # image 129M | 55.4 | |
| | | REVEAL | CC12M + Wikidata + WIT + | 55.2 | |
| | | | VQA-v2 | | |
| | | Augmented | 4 million images + Wikidata | 57.7 | |
| | | vector extraction | | | |
| | | model | | | |
| Knowledge- | AOK-VQA | ALBEF | # images 12M | 54.5 | — |
| based | | BLIP | # images 129M | 56.2 | 50.1 |
| downstream | | REVEAL | CC12M + Wikidata + WIT + | — | 50.4 |
| task | | | VQA-v2 | | |
| | | Augmented | # images 4M + Wikidata | 58.4 | 52.7 |
| | | vector extraction | | | |
| | | model | | | |
| Downstream | VQA-v2 | VL-BERT | # images 3.3M | 71.16 | — |
| task of | (basic | UNITER | # images 4M | 72.70 | 72.91 |
| universal | data | OSCAR | # images 4M | 73.16 | 73.44 |
| visual | training) | ALBEF | # images 4M | 74.54 | 74.70 |
| language | | Augmented | # images 4M + Wikidata | 77.62 | 77.79 |
| | | vector extraction | | | |
| | | model | | | |
| | VQA-v2 | ALBEF | # images 12M | 75.84 | 76.04 |
| | (massive | BLIP | # images 14M | 77.54 | 77.62 |
| | data | BLIP | # images 129M | 78.25 | 78.32 |
| | training) | Sim VLM | # images 1.8B | 77.87 | 78.14 |
| | SNLI-VE | UNITER | # images 4M | 79.39 | 79.38 |
| | | ALBEF | # images 4M | 80.14 | 80.30 |
| | | Augmented | # images 4M + Wikidata | 82.41 | 82.53 |
| | | vector extraction | | | |
| | | model | | | |
| | | ALBEF | # images 12M | 80.80 | 80.91 |

KAT is short for knowledge augmented transformer. REVIVE is a visual question answering model. ALBEF is short for align before fuse and implements vision and language representation learning with momentum distillation. BLIP is a multi-modal visual language model. REVEAL is short for retrieval-augmented visual-language pre-training with multi-source multimodal knowledge memory, and is a multi-source multimodal visual-language pre-training model. VL-BERT is a universal visual language model. UNITER is short for universal image-text representation learning and is a multimodal pre-training model. OSCAR is short for object-semantics aligned pre-training for vision-language tasks and is a multimodal pre-training model. Sim VLM is a simple visual-language pre-training model with weak supervision.

Wiki data indicates Wiki data, #image 12M indicates 12 million images, #image 129M indicates 129 million images, and other content related to #image is similar. CC12M indicates 12 million image-text pairs, and WIT indicates wikipedia-based image text database-GitHub.

With reference to knowledge-based downstream tasks, in an outside knowledge-visual question answering (OK-VQA) dataset, compared with KAT, REVIVE, ALBEF, BLIP, and REVEAL, the augmented vector extraction model has improved accuracy, and compared with currently advanced REVIVE and BLIP, the augmented vector extraction model has higher accuracy gains. Compared with REVEAL, the augmented vector extraction model can have better performance with fewer knowledge graph resources. In an AOK-VQA dataset, compared with ALBEF, BLIP, and REVEAL, the augmented vector extraction model also has improved accuracy.

With reference to downstream tasks of a universal visual language, in a visual question answering-v2 (VQA-v2) dataset, based on basic data training, compared with VL-BERT, UNITER, OSCAR, and ALBEF, the augmented vector extraction model also has improved accuracy. In a VQA-v2 dataset, based on massive data training, the augmented vector extraction model is also very competitive.

With reference to downstream tasks of a universal visual language, in a Stanford natural language inference-visual entailment (SNLI-VE) dataset, compared with VL-BERT, UNITER, OSCAR, and ALBEF, the augmented vector extraction model also has improved accuracy.

In some embodiments, entity retrieval capabilities of the augmented vector extraction model are detected, and the augmented vector extraction model is compared with related multimodal entity retrieval models. A comparison result is shown in Table 2.

TABLE 2

| | Indi- | Indi- | Indi- | Indi- | Indi- | Indi- |
|---|---|---|---|---|---|---|
| Model | cator 1 | cator 2 | cator 3 | cator 4 | cator 5 | cator 6 |
| ViT + BERT | 61.76 | 71.30 | 73.87 | 60.56 | 72.43 | 78.72 |
| ResNet + | 77.64 | 81.21 | 85.69 | 68.24 | 79.83 | 82.65 |
| CLIP_N | | | | | | |
| ResNet + | 80.64 | 84.33 | 87.56 | 73.70 | 83.47 | 84.45 |
| CLIP_N_D | | | | | | |
| CLIP | 82.37 | 87.82 | 91.04 | 74.55 | 84.42 | 85.15 |
| Augmented | 83.20 | 88.42 | 89.59 | 77.58 | 85.27 | 88.38 |
| vector | | | | | | |
| extraction | | | | | | |
| model | | | | | | |

ViT+BERT is short for vision transformer+bidirectional encoder representation from transformer, and is a vision transformer+a language representation model. ResNet is a residual network. CLIP uses texts as a supervised signal to train a transferable visual model. As can be seen, in scores of models in 6 indicators, scores of the augmented vector extraction model in five indicators are higher than those of the related multimodal entity retrieval models.

In the recommendation model processing method, the first media training vector and the first text training vector are extracted by using the feature extraction model, the entity training vector is retrieved from the knowledge graph according to the first media training vector, and feature fusion processing is performed on the first media training vector, the first text training vector, and the entity training vector, to obtain the knowledge augmented training vector, that is, an entity related to the first media sample data is retrieved from the knowledge graph, and the entity training vector of the related entity, the first media training vector, and the first text vector are fused, to implement multimodal data interaction. This augments representation of the first media sample data, the first text sample, and the related entity and improves quality of the knowledge augmented training vector. Parameters of the feature extraction model, the knowledge retrieval model, and the knowledge augmented model are adjusted jointly based on the visual loss value, the language loss value, and the knowledge retrieval loss value, so that in a parameter adjustment process, content information of the first media sample data and the first text sample can be learned, and entity information related to the first media sample data can also be learned, thereby improving quality of the augmented vector extraction model obtained through training, and further improving quality of the recommendation model including the augmented vector extraction model. The target media data recommended to the target object is determined based on the recommendation model, thereby improving media recommendation. In this way, the target object can browse the media data in which the target object is interested without performing manual search, thereby reducing resource consumption caused by manual search and improving resource utilization.

Although the operations are displayed sequentially according to the instructions of the arrows in the flowcharts of the embodiments, these operations are not necessarily performed sequentially according to the sequence instructed by the arrows. Unless otherwise explicitly specified in this disclosure, execution of the operations is not strictly limited, and the operations may be performed in other sequences. Moreover, at least some of the operations in flowcharts in each embodiment may include a plurality of operations or a plurality of stages. The operations or stages are not necessarily performed at the same moment, and instead may be performed at different moments. Execution of the operations or stages is not necessarily sequentially performed, and instead may be performed in turn or alternately with other operations or at least some operations or stages of other operations.

Based on the same inventive concept, an embodiment of this disclosure further provides a media data recommendation apparatus configured to implement the foregoing media data recommendation method. The problem solving implementation provided by the apparatus is similar to the implementation recorded in the above method. Therefore, for specific definitions in one or more embodiments of the media data recommendation apparatus provided below, refer to the above definitions in the above media data recommendation method.

In some embodiments, as shown in FIG. 15, a media data recommendation apparatus is provided, including: a vector extraction module 1501, a first knowledge retrieval module 1502, a first fusion module 1503, and a recommendation module 1504.

The vector extraction module 1501 is configured to extract a media representation vector and a text representation vector from media data and a description text of the media data.

The first knowledge retrieval module 1502 is configured to perform knowledge retrieval in a knowledge graph according to the media representation vector, to obtain an entity sub-graph of the media data, and determine an entity representation vector of the entity sub-graph.

The first fusion module 1503 is configured to perform feature fusion processing on the media representation vector, the text representation vector, and the entity representation vector, to obtain a knowledge augmented vector.

The recommendation module 1504 is configured to obtain target media data based on the knowledge augmented vector, and recommend the target media data to a target object.

In some embodiments, the vector extraction module 1501 includes: a media representation vector extraction unit and a text representation vector extraction unit.

The media representation vector extraction unit is configured to extract features of the media data by using an image feature extraction model, to obtain the media representation vector.

The text representation vector extraction unit is configured to extract the text representation vector from the description text of the media data by using a text feature extraction model.

In some embodiments, the media representation vector extraction unit is further configured to extract, when the media data is a video, features of a plurality of image frames in the video by using the image feature extraction model, to obtain the media representation vector; and extract, when the media data is an image, features of a plurality of image blocks of the image by using the image feature extraction model, to obtain the media representation vector.

In some embodiments, the first knowledge retrieval module 1502 includes:

a target entity determining unit, configured to retrieve, based on the media representation vector, a plurality of target entities related to the media data from the knowledge graph;

an entity sub-graph determining unit, configured to determine the entity sub-graph of the media data based on the plurality of target entities and the knowledge graph; and

an entity representation vector determining unit, configured to extract features of a plurality of entities in the entity sub-graph, to obtain the entity representation vector.

In some embodiments, the media representation vector includes at least two image representation sub-vectors; and the target entity determining unit is further configured to obtain initial entity vectors of a plurality of entities in the knowledge graph; retrieve candidate entities from the knowledge graph according to the plurality of initial entity vectors and the at least two image representation sub-vectors; and select the plurality of target entities related to the media data from the candidate entities.

In some embodiments, the target entity determining unit further includes a candidate entity retrieval subunit, configured to determine a correlation degree set of the at least two image representation sub-vectors according to the plurality of initial entity vectors and the at least two image representation sub-vectors, where the correlation degree set includes correlation degrees between the image representation sub-vectors and initial entity vectors, and select, according to the correlation degree set, candidate entities related to the at least two image representation sub-vectors from the knowledge graph.

In some embodiments, the entity sub-graph determining unit is further configured to determine a neighboring node of each target entity in the knowledge graph; determine extended entities according to the plurality of target entities and the neighboring node of each target entity, and determine a relationship between the extended entities in the knowledge graph, and determine the entity sub-graph of the media data according to the extended entities and the relationship between the extended entities. In some embodiments, the target entity determining unit is further configured to retrieve, based on the media representation vector by using a retrieval sub-model of a knowledge retrieval model, the plurality of target entities related to the media data from the knowledge graph; the entity sub-graph determining unit is further configured to determine, based on the plurality of target entities and the knowledge graph by using a sub-graph construction network of the knowledge retrieval model, the entity sub-graph corresponding to the media data; and the entity representation vector determining unit is further configured to extract the features of the plurality of entities in the entity sub-graph by using a graph neural network of the knowledge retrieval model, to obtain the entity representation vector.

In some embodiments, the first fusion module 1503 is further configured to concatenate the media representation vector, the text representation vector, and the entity representation vector, and add a separation element between the media representation vector and the text representation vector and add a separation element between the text representation vector and the entity representation vector during the concatenating, to obtain a concatenated vector; and perform feature fusion processing on the concatenated vector by using a knowledge augmented model, to obtain the knowledge augmented vector.

In some embodiments, the recommendation module 1504 is further configured to perform classification processing on the knowledge augmented vector, to obtain an interest type of the target object; and obtain the target media data according to the interest type, and recommend the target media data to a target object.

All or some of the modules in the media data recommendation apparatus may be implemented by software, hardware, and a combination thereof. The above-mentioned modules can be embedded in the processor in the computer device in the form of hardware or independent of the processor in the computer device, and can also be stored in the memory of the computer device in the form of software, so that the processor can invoke and execute the corresponding operations of the above-mentioned modules.

Based on the same inventive concept, an embodiment of this disclosure further provides a media data recommendation apparatus configured to implement the foregoing media data recommendation method. The problem solving implementation provided by the apparatus is similar to the implementation recorded in the above method. Therefore, for specific definitions in one or more embodiments of the media data recommendation apparatus provided below, refer to the above definitions in the above media data recommendation method.

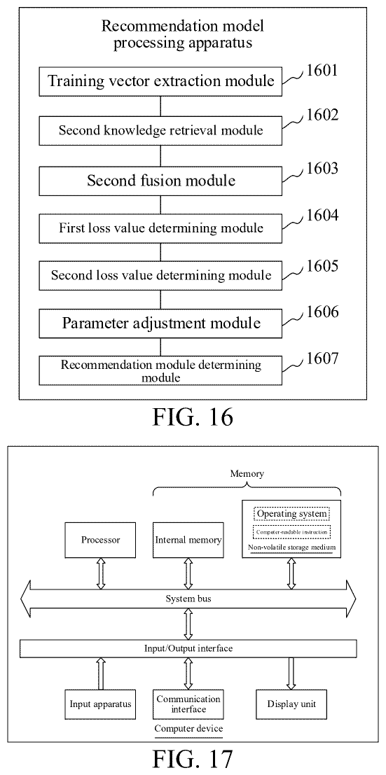

In some embodiments, as shown in FIG. 16, a recommendation model processing apparatus is provided, including: a training vector extraction module 1601, a second knowledge retrieval module 1602, a second fusion module 1603, a first loss value determining module 1604, a second loss value determining module 1605, a parameter adjustment module 1606, and a recommendation model determining module 1607.

The training vector extraction module 1601 is configured to extract a first media training vector and a first text training vector from first sample media data and a first sample text of the first sample media data based on a feature extraction model.

The second knowledge retrieval module 1602 is configured to perform knowledge retrieval processing on the first media training vector and a knowledge graph based on a knowledge retrieval model, to obtain a training sub-graph of the first sample media data, and determine an entity training vector of the training sub-graph.

The second fusion module 1603 is configured to perform feature fusion processing on the first media training vector, the first text training vector, and the entity training vector based on a knowledge augmented model, to obtain a knowledge augmented training vector.

The first loss value determining module 1604 is configured to determine a visual loss value and a language loss value according to the knowledge augmented training vector and a sample label.

The second loss value determining module 1605 is configured to determine a knowledge retrieval loss value according to the knowledge augmented training vector and the training sub-graph.

The parameter adjustment module 1606 is configured to adjust parameters of the feature extraction model, the knowledge retrieval model, and the knowledge augmented model based on the visual loss value, the language loss value, and the knowledge retrieval loss value, to obtain an augmented vector extraction model.

The recommendation model determining module 1607 is configured to determine a recommendation model based on the augmented vector extraction model and a classification model, the recommendation model being configured for extracting a knowledge augmented vector according to media data, a description text, and the knowledge graph, and determining an interest type based on the knowledge augmented vector, to obtain target media data based on the interest type and recommend the target media data to a target object.

In some embodiments, the knowledge augmented training vector includes a media augmented training vector and a text augmented training vector, and the sample label includes a masked sub-image label and a masked word label; and the first loss value determining module 1604 is configured to obtain a masked sub-image augmented vector in the media augmented training vector, and determine the visual loss value according to the masked sub-image augmented vector and the masked sub-image label; and perform classification processing on the text augmented training vector to obtain a masked word prediction probability, and determine the language loss value based on the masked word prediction probability and the masked word label.

In some embodiments, the second loss value determining module 1605 is further configured to obtain a positive entity sample pair from the training sub-graph, and determine a first score of the positive entity sample pair according to the entity augmented training vector; obtain a negative entity sample pair from the training sub-graph, and determine a second score of the negative entity sample pair according to the entity augmented training vector, where the negative entity sample pair includes two training entities that have no entity relationship in the training sub-graph; and determine the knowledge retrieval loss value based on the first score and the second score.

In some embodiments, the first sample media data and first sample text belong to a sample set, and the sample set further includes second sample media data and a second sample text; and the recommendation model processing apparatus further includes a third loss value determining module, configured to extract features of the second sample media data and the second sample text, to obtain a second media training vector and a second text training vector; and determine an image text comparison loss value according to the second media training vector, the second text training vector, the first media training vector, and the first text training vector.

Correspondingly, the parameter adjustment module 1606 is configured to adjust the parameters of the feature extraction model, the knowledge retrieval model, and the knowledge augmented model based on the visual loss value, the language loss value, the knowledge retrieval loss value, and an image text comparison loss value, to obtain the augmented vector extraction model.

In some embodiments, the third loss value determining module includes an image text comparison loss value determining unit, configured to determine a first similarity degree according to the first media training vector and the second text training vector; determine a second similarity degree according to the first text training vector and the second media training vector; and determine the image text comparison loss value according to the first similarity degree, the second similarity degree, a first similarity degree label, and a second similarity degree label.

All or some of the modules in the recommendation model processing apparatus may be implemented by software, hardware, and a combination thereof. The above-mentioned modules can be embedded in the processor in the computer device in the form of hardware or independent of the processor in the computer device, and can also be stored in the memory of the computer device in the form of software, so that the processor can invoke and execute the corresponding operations of the above-mentioned modules.

In an embodiment, a computer device is provided and can be a server. An internal structure thereof can be shown in FIG. 17. The computer device includes a processor, a memory, an input/output (I/O) interface, and a communication interface. The processor, the memory, and the input/output interface are connected to each other by using a system bus, and the communication interface is connected to the system bus by using the input/output interface. The processor of the computer device is configured to provide computation and control ability. The memory of the computer device includes a non-volatile storage medium and an inner memory. The non-volatile storage medium stores an operating system, computer programs, and databases. The inner memory provides an operating environment for the operating system and the computer programs in the non-volatile storage medium. The database of the computer device is configured to store the recommendation model, the target media data, and the sample set. The input/output interface of the computer device is configured to exchange information between the processor and external devices. The communication interface of the computer device is configured to communicate with an external terminal by using a network connection. The computer program is executed by the processor to implement the media data recommendation method or the recommendation model processing method.

It is noted that, the structure shown in FIG. 17 is merely a block diagram of a partial structure related to a solution in this disclosure, and does not constitute a limitation to the computer device to which the solution in this disclosure is applied. In some examples, the computer device may include more components or fewer components than those shown in the figure, or some components may be combined, or a different component deployment may be used.

In an embodiment, a computer device is provided, including: a memory and a processor. The memory has a computer program stored therein, and the computer program, when executed by a processor, implements the foregoing media data recommendation method or recommendation model processing method. In an embodiment, a computer-readable storage medium is provided, having a computer program stored therein, the computer program, when executed by a processor, implementing the foregoing media data recommendation method or recommendation model processing method.

In an embodiment, a computer program product is provided, including a computer program, the computer program, when executed by a processor, implementing the foregoing media data recommendation method or recommendation model processing method. User information (including, but not limited to, user equipment information, user personal information, and the like) and data (including, but not limited to, data for analysis, stored data, displayed data, and the like) involved in this disclosure are all information and data authorized by users or fully authorized by all parties, and collection, use, and processing of relevant data need to comply with relevant laws, regulations, and standards of relevant countries and regions.

It is noted that all or some of procedures of the method in the foregoing embodiments may be implemented by a computer program instructing relevant hardware. The computer program may be stored in a non-volatile computer-readable storage medium. When the computer program is executed, the procedures of the foregoing method embodiments may be implemented. References to the memory, the database, or other medium used in the embodiments provided in this disclosure may all include at least one of a non-volatile or a volatile memory. The non-volatile memory can include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, or the like. The volatile memory may include a random-access memory (RAM) and an external cache. As an illustration and not a limitation, the RAM can be in various forms, such as a static random access memory (SRAM) or a dynamic random access memory (DRAM). The database involved in the various embodiments provided in this disclosure may include at least one of a relational database and a non-relational database. The non-relational database may include a blockchain-based distributed database or the like, but is not limited thereto. The processors involved in the various embodiments provided by this disclosure can be general-purpose processors, central processing units, graphic processing units, digital signal processors, programmable logic devices, data processing logic devices based on quantum computing, and are not limited thereto.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to Care intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Technical features of the foregoing embodiments may be combined in various manners. To make description concise, not all combinations of the technical features in the foregoing embodiments are described. However, the combinations of these technical features shall be considered as falling within the scope recorded by this specification provided that no conflict exists.

The foregoing disclosure includes some embodiments of this disclosure which are not intended to limit the scope of this disclosure. Other embodiments shall also fall within the scope of this disclosure.

What is claimed is:

1. A method of media data recommendation, comprising:
extracting a media representation vector from media data and a text representation vector from a description text of the media data;
performing a knowledge retrieval in a knowledge graph according to the media representation vector, to obtain an entity sub-graph of the media data;
determining an entity representation vector of the entity sub-graph;
performing a feature fusion processing on the media representation vector, the text representation vector, and the entity representation vector, to obtain a knowledge augmented vector;
obtaining target media data based on the knowledge augmented vector, the knowledge augmented vector being a fused vector of the media representation vector, the text representation vector, and the entity representation vector, and
recommending the target media data to a target object.

2. The method according to claim 1, wherein the extracting comprises:
extracting the media representation vector from the media data by using an image feature extraction model; and
extracting the text representation vector from the description text of the media data by using a text feature extraction model.

3. The method according to claim 2, wherein the extracting the media representation vector comprises:
extracting, when the media data is a video, features of a plurality of image frames in the video by using the image feature extraction model, to obtain the media representation vector; and
extracting, when the media data is an image, features of a plurality of image blocks in the image by using the image feature extraction model, to obtain the media representation vector.

4. The method according to claim 1, wherein the performing the knowledge retrieval comprises:
retrieving, from the knowledge graph and based on the media representation vector, a plurality of target entities that are related to the media data;
determining the entity sub-graph of the media data based on the plurality of target entities and the knowledge graph; and
extracting features of a plurality of entities in the entity sub-graph, to obtain the entity representation vector.

5. The method according to claim 4, wherein the media representation vector comprises at least two image representation sub-vectors; and the retrieving the plurality of target entities comprises:
obtaining initial entity vectors of a plurality of entities in the knowledge graph;
retrieving candidate entities from the knowledge graph according to the initial entity vectors and the at least two image representation sub-vectors; and
selecting, from the candidate entities, the plurality of target entities that are related to the media data.

6. The method according to claim 5, wherein the retrieving the candidate entities comprises:
determining a correlation degree set of the at least two image representation sub-vectors according to the initial entity vectors and the at least two image representation sub-vectors, the correlation degree set comprising respective correlation degrees between the at least two image representation sub-vectors and the initial entity vectors; and
selecting, according to the correlation degree set, the candidate entities that are related to the at least two image representation sub-vectors.

7. The method according to claim 4, wherein the determining the entity sub-graph comprises:
determining respective neighboring nodes of the plurality of target entities in the knowledge graph;
determining extended entities according to the plurality of target entities and the respective neighboring nodes of the plurality of target entities;
determining relationships between the extended entities in the knowledge graph; and
determining the entity sub-graph of the media data according to the extended entities and the relationships between the extended entities.

8. The method according to claim 4, wherein:
the retrieving the plurality of target entities comprises:
retrieving, based on the media representation vector and by using a retrieval sub-model of a knowledge retrieval model, the plurality of target entities that are related to the media data;
the determining the entity sub-graph comprises:
determining, based on the plurality of target entities and the knowledge graph and by using a sub-graph construction network of the knowledge retrieval model, the entity sub-graph corresponding to the media data; and
the extracting the features comprises:
extracting the features of the plurality of entities in the entity sub-graph by using a graph neural network of the knowledge retrieval model, to obtain the entity representation vector.

9. The method according to claim 1, wherein the performing the feature fusion processing comprises:
concatenating the media representation vector, the text representation vector, and the entity representation vector;
adding a first separation element between the media representation vector and the text representation vector and a second separation element between the text representation vector and the entity representation vector during the concatenating, to obtain a concatenated vector; and
performing a feature fusion processing on the concatenated vector by using a knowledge augmented model, to obtain the knowledge augmented vector.

10. The method according to claim 1, wherein the obtaining the target media data comprises:
performing a classification processing on the knowledge augmented vector, to obtain one or more interest types of the target object; and
obtaining the target media data according to the one or more interest types.

11. A method of recommendation model processing, comprising:
extracting, by using one or more feature extraction models, a first media training vector from first sample media data and a first text training vector from a first sample text of the first sample media data;
performing, by using a knowledge retrieval model, a knowledge retrieval processing on the first media training vector and a knowledge graph to obtain a training sub-graph of the first sample media data;
determining an entity training vector of the training sub-graph;
performing, by using a knowledge augmented model, a feature fusion processing on the first media training vector, the first text training vector, and the entity training vector to obtain a knowledge augmented training vector;
determining a visual loss value and a language loss value according to the knowledge augmented training vector and a sample label of the first sample media data;
determining a knowledge retrieval loss value according to the knowledge augmented training vector and the training sub-graph;
adjusting parameters of the one or more feature extraction models, the knowledge retrieval model, and the knowledge augmented model based on the visual loss value, the language loss value, and the knowledge retrieval loss value, to obtain an augmented vector extraction model, the augmented vector extraction model including the one or more feature extraction models, the knowledge retrieval model and the knowledge augmented model; and
determining a recommendation model based on the augmented vector extraction model and a classification model, the recommendation model including the augmented vector extraction model and the classification model, the recommendation model providing target media data to a target object based on media data, a description text of the media data and the knowledge graph.

12. The method according to claim 11, wherein:
the knowledge augmented training vector comprises a media augmented training vector and a text augmented training vector, and the sample label comprises a masked sub-image label and a masked word label; and
the determining the visual loss value and the language loss value comprises:
obtaining a masked sub-image augmented vector in the media augmented training vector,
determining the visual loss value according to the masked sub-image augmented vector and the masked sub-image label; performing a classification processing on the text augmented training vector to obtain a masked word prediction probability, and
determining the language loss value based on the masked word prediction probability and the masked word label.

13. The method according to claim 11, wherein:
the knowledge augmented training vector further comprises an entity augmented training vector; and
the determining the knowledge retrieval loss value comprises:
obtaining a positive entity sample pair from the training sub-graph, two entities in the positive entity sample pair having an entity relationship in the training sub-graph;
determining a first score of the positive entity sample pair according to the entity augmented training vector;
obtaining a negative entity sample pair from the training sub-graph, two entities in the negative entity sample pair having no entity relationship in the training sub-graph;
determining a second score of the negative entity sample pair according to the entity augmented training vector; and
determining the knowledge retrieval loss value based on the first score and the second score.

14. The method according to claim 11, wherein:
the first sample media data and the first sample text belong to a sample set, and the sample set further comprises second sample media data and a second sample text of the second sample media data;
the method further comprises:
extracting a second media training vector from the second sample media data and a second text training vector from the second sample text; and
determining an image text comparison loss value according to the second media training vector, the second text training vector, the first media training vector, and the first text training vector; and
the adjusting the parameters comprises:
adjusting the parameters of the one or more feature extraction models, the knowledge retrieval model, and the knowledge augmented model based on the visual loss value, the language loss value, the knowledge retrieval loss value, and the image text comparison loss value, to obtain the augmented vector extraction model.

15. The method according to claim 14, wherein the determining the image text comparison loss value comprises:
determining a first similarity degree according to the first media training vector and the second text training vector;
determining a second similarity degree according to the first text training vector and the second media training vector; and
determining the image text comparison loss value according to the first similarity degree, the second similarity degree, a first similarity degree label for the first media training vector and the second text training vector, and a second similarity degree label for the first text training vector and the second media training vector.

16. An apparatus for media data recommendation, comprising processing circuitry configured to:
extract a media representation vector from media data and a text representation vector from a description text of the media data;
perform knowledge retrieval in a knowledge graph according to the media representation vector, to obtain an entity sub-graph of the media data;
determine an entity representation vector of the entity sub-graph;
perform a feature fusion processing on the media representation vector, the text representation vector, and the entity representation vector, to obtain a knowledge augmented vector;
obtain target media data based on the knowledge augmented vector that is a fused vector of the media representation vector, the text representation vector, and the entity representation vector, and
recommend the target media data to a target object.

17. The apparatus according to claim 16, wherein the processing circuitry is configured to:
extract the media representation vector from the media data by using an image feature extraction model; and
extract the text representation vector from the description text of the media data by using a text feature extraction model.

18. The apparatus according to claim 17, wherein the processing circuitry is configured to:
extract, when the media data is a video, features of a plurality of image frames in the video by using the image feature extraction model, to obtain the media representation vector; and
extract, when the media data is an image, features of a plurality of image blocks in the image by using the image feature extraction model, to obtain the media representation vector.

19. The apparatus according to claim 16, wherein the processing circuitry is configured to:
retrieve, from the knowledge graph and based on the media representation vector, a plurality of target entities that are related to the media data;
determine the entity sub-graph of the media data based on the plurality of target entities and the knowledge graph; and
extract features of a plurality of entities in the entity sub-graph, to obtain the entity representation vector.

20. The apparatus according to claim 19, wherein the media representation vector comprises at least two image representation sub-vectors; and the processing circuitry is configured to:
obtain initial entity vectors of a plurality of entities in the knowledge graph;
retrieve candidate entities from the knowledge graph according to the initial entity vectors and the at least two image representation sub-vectors; and
select from the candidate entities, the plurality of target entities that are related to the media data.
